(19) United States
(12) Patent Application Publication
(10) Pub. No.: US 2025/0159617 A1
(43) Pub. Date: May 15, 2025

(54) STABLE POWER HEADROOM REFERENCE FOR CARRIER AGGREGATION

(71) Applicant: QUALCOMM Incorporated, San Diego, CA (US)

(72) Inventors: Timo Ville VINTOLA, San Diego, CA (US); Toni Harri Henrikki LAEHTEENSUO, Helsinki (FI); Brahim SAADI, Nuremberg (DE); Peter GAAL, San Diego, CA (US)

(21) Appl. No.: 18/883,983

(22) Filed: Sep. 12, 2024

Related U.S. Application Data
(60) Provisional application No. 63/598,065, filed on Nov. 10, 2023.

(51) Int. Cl. H04W 52/36; H04L 5/00; H04W 72/12

(52) U.S. Cl. CPC H04W 52/365; H04L 5/001; H04W 72/12

(57) ABSTRACT

Various aspects of the present disclosure generally relate to wireless communication. In some aspects, a user equipment (UE) may receive configuration information indicative of a carrier aggregation configuration associated with a first component carrier (CC) and a second CC. The UE may receive scheduling information indicative of at least one scheduled transmission during a transmission occasion associated with at least one of the first CC or the second CC. The UE may transmit, using at least one transmission power during the transmission occasion, at least one communication on the at least one of the first CC or the second CC. The at least one transmission power is based at least in part on a maximum transmission power limit and a power headroom (PHR) reference value that is determined independently of the maximum transmission power limit. Numerous other aspects are described.

### CROSS-REFERENCE TO RELATED APPLICATION

This Patent application claims priority to U.S. Provisional Patent Application No. 63/598,065, filed on Nov. 10, 2023, entitled “STABLE POWER HEADROOM REFERENCE FOR CARRIER AGGREGATION,” and assigned to the assignee hereof. The disclosure of the prior Application is considered part of and is incorporated by reference into this Patent Application.

### INTRODUCTION

Aspects of the present disclosure generally relate to wireless communication and specifically relate to techniques, apparatuses, and methods associated with power headroom reference values.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled to the one or more memories. The one or more processors may be configured to cause the UE to receive configuration information indicative of a carrier aggregation configuration associated with a first component carrier (CC) and a second CC. The one or more processors may be configured to cause the UE to receive scheduling information indicative of at least one scheduled transmission during a transmission occasion associated with at least one of the first CC or the second CC. The one or more processors may be configured to cause the UE to transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

Some aspects described herein relate to an apparatus for wireless communication at a network node. The apparatus may include one or more memories and one or more processors coupled to the one or more memories. The one or more processors may be configured to cause the network node to transmit configuration information indicative of a carrier aggregation configuration associated with a first CC and a second CC. The one or more processors may be configured to cause the network node to transmit scheduling information indicative of at least one scheduled transmission during a transmission occasion associated with at least one of the first CC or the second CC. The one or more processors may be configured to cause the network node to receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Some aspects described herein relate to a method of wireless communication performed at a UE. The method may include receiving configuration information indicative of a carrier aggregation configuration associated with a first CC and a second CC. The method may include receiving scheduling information indicative of at least one scheduled transmission during a transmission occasion associated with at least one of the first CC or the second CC. The method may include transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Some aspects described herein relate to a method of wireless communication performed at a network node. The method may include transmitting configuration information indicative of a carrier aggregation configuration associated with a first CC and a second CC. The method may include transmitting scheduling information indicative of at least one scheduled transmission during a transmission occasion associated with at least one of the first CC or the second CC. The method may include receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Some aspects described herein relate to a non-transitory computer-readable medium that stores a set of instructions for wireless communication by a UE. The set of instructions, when executed by one or more processors of the UE, may cause the UE to receive configuration information indicative of a carrier aggregation configuration associated with a first CC and a second CC. The set of instructions, when executed by one or more processors of the UE, may cause the UE to receive scheduling information indicative of at least one scheduled transmission during a transmission occasion associated with at least one of the first CC or the second CC. The set of instructions, when executed by one or more processors of the UE, may cause the UE to transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Some aspects described herein relate to a non-transitory computer-readable medium that stores a set of instructions for wireless communication by a network node. The set of instructions, when executed by one or more processors of the network node, may cause the network node to transmit configuration information indicative of a carrier aggregation configuration associated with a first CC and a second CC. The set of instructions, when executed by one or more processors of the network node, may cause the network node to transmit scheduling information indicative of at least one scheduled transmission during a transmission occasion associated with at least one of the first CC or the second CC. The set of instructions, when executed by one or more processors of the network node, may cause the network node to receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Some aspects described herein relate to an apparatus for wireless communication. The apparatus may include means for receiving configuration information indicative of a carrier aggregation configuration associated with a first CC and a second CC. The apparatus may include means for receiving scheduling information indicative of at least one scheduled transmission during a transmission occasion associated with at least one of the first CC or the second CC. The apparatus may include means for transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Some aspects described herein relate to an apparatus for wireless communication. The apparatus may include means for transmitting configuration information indicative of a carrier aggregation configuration associated with a first CC and a second CC. The apparatus may include means for transmitting scheduling information indicative of at least one scheduled transmission during a transmission occasion associated with at least one of the first CC or the second CC. The apparatus may include means for receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIGS. 4A and 4B are diagrams illustrating an example associated with determining power transmissions in association with carrier aggregation (CA) configurations, in accordance with the present disclosure.

FIGS. 5A-5C are diagrams of examples associated with stable power headroom (PHR) references for carrier aggregation, in accordance with the present disclosure.

FIGS. 6A-6B are diagrams of an example associated with stable PHR references for carrier aggregation, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram illustrating an example of a hardware implementation for an apparatus employing a processing system, in accordance with the present disclosure.

FIG. 11 is a diagram illustrating an example of an implementation of code and circuitry for an apparatus, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

### DETAILED DESCRIPTION

Carrier aggregation (CA) is a technology that enables two or more component carriers (CCs, sometimes referred to as carriers) to be combined (e.g., into a single channel) for a single user equipment (UE) to enhance data capacity. Carriers can be combined in the same or different frequency bands. Additionally, or alternatively, contiguous or non-contiguous carriers can be combined. A network node may configure carrier aggregation for a UE, such as in a radio resource control (RRC) message, downlink control information (DCI), and/or another signaling message.

In some aspects, carrier aggregation may be configured in an intra-band contiguous mode where the aggregated carriers are contiguous to one another and are in the same band. In some aspects, carrier aggregation may be configured in an intra-band non-contiguous mode where the aggregated carriers are non-contiguous to one another and are in the same band. In some aspects, carrier aggregation may be configured in an inter-band non-contiguous mode where the aggregated carriers are non-contiguous to one another and are in different bands.

In carrier aggregation, a UE may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some cases, a UE may determine transmission power(s) (e.g., one or more transmission powers) and may transmit at least one communication. For example, the UE may transmit the at least one communication using the determined transmission power(s). In some cases, for example, the UE may be configured with a CA configuration indicative of a first component carrier (CC) and a second CC. The first CC may be associated with a first band and the second CC may be associated with a second band. The UE may be configured to determine whether the configuration information and/or scheduling information received from the network node indicates that there are to be parallel transmissions during a transmission occasion. For example, parallel transmissions may be two or more transmissions that are configured and/or scheduled to be transmitted within a same transmission occasion and that at least partially overlap in a time domain. A transmission occasion may include a set of time resources and/or frequency resources that are allocated, reserved, or otherwise used for a type of transmission. For example, a transmission occasion may include a random access channel (RACH) occasion for transmission of a RACH message, a paging occasion (PO) for transmission of a paging occasion, or another type of transmission occasion. Non-parallel transmissions may be two or more transmissions that do not at least partially overlap in the time domain.

In some cases, the UE may be configured to transmit one or more uplink communications. The UE can transmit an uplink communication using a transmission power, which can be determined by the UE and/or configured by the network node. The transmission power may be limited by a maximum transmission power limit (sometimes referred to as a “maximum transmit power”) which refers to a maximum allowed transmission power (e.g., defined in a wireless communication standard), a configured maximum output power PCMAX, a configured maximum output power PCMAX,f for a carrier f, a configured maximum output power PCMAX,c for a cell c (e.g., a serving cell), a configured maximum output power PCMAX,f,c for a carrier f of a cell c, and/or a maximum transmit power determined based at least in part on a maximum power reduction, among other examples.

The maximum transmission power limit may be determined in accordance with a per-band UE power class, which is a specified maximum UE transmission power associated with a band (e.g., a CC). In scenarios involving CA, the maximum transmission power limit may be determined in accordance with the per-band UE power class and/or a power class for CA, which is a specified maximum of a sum of UE transmission powers associated with the configured CCs. In some cases, the maximum transmission power also may be determined in accordance with a per band per-band-combination UE power class, which is a specified per band maximum UE transmission power associated with a combination of bands (e.g., a combination of CCs in CA).

In some cases, the transmission power also may be limited by a power headroom report (PHR) value (which may be referred to as a “power headroom value” or a “power headroom”). A power headroom may indicate an amount of remaining transmission power available to a UE in addition to power being used by a current transmission. The power headroom may be based at least in part on a difference between a UE maximum transmission power and a transmission power. A PHR may be a Type 1 report for a physical uplink shared channel (PUSCH), a Type 3 report for a sounding reference signal (SRS), and/or a Type 2 report for a physical uplink control channel (PUCCH), among other examples. For example, types of UE PHRs may include a Type 1 UE power headroom that is valid for a PUSCH transmission occasion i on an active uplink (UL) bandwidth part (BWP) b of CC f of serving cell c, or a Type 3 UE power headroom that is valid for an SRS transmission occasion i on an active UL BWP b of CC f of serving cell c. Thus, a PHR may be determined for a CC and/or serving cell.

A UE may determine whether a PHR for an activated serving cell is based at least in part on an actual transmission. The actual transmission may be determined based at least in part on higher layer signalling of configured grant and periodic/semi-persistent sounding reference signal transmissions, and/or downlink control information (DCI) received by the UE. The UE may determine whether the PHR for the activated serving cell is based at least in part on a reference format. The reference format may be determined based at least in part on higher layer signalling of configured grant and periodic/semi-persistent sounding reference signal transmissions, and/or DCI received by the UE. The UE may determine whether the PHR for the activated serving cell is based at least in part on a reference format. In some cases, then, a PHR value may be calculated as a difference between a maximum transmission power limit (e.g., PCMAX) and a transmission power that would have been used without power constraints (e.g., which may be an unconstrained transmission power for a single signal or a sum of unconstrained transmission powers for multiple signals, such as higher priority signals).

For example, in some cases, a UE may periodically measure its available power headroom and report it to a network node. This reporting can be initiated by the network node through specific signaling messages and/or can be triggered based on one or more PHR triggers. The network node can configure the PHR parameters for the UE, including the reporting periodicity and the measurement rules. The reporting periodicity determines how often the UE sends the PHR, while the measurement rules define how the UE calculates its power headroom. For example, as indicated above, the UE can calculate a power headroom by considering factors such as the maximum transmission power defined by the network, the current transmission power, and/or any power limitations due to neighboring cells and/or interference, among other examples. The calculation can result in a PHR that provides a representation of the power available to the UE for transmission. In some cases, the UE can transmit the PHR to the network node over an uplink channel. The PHR can include the power headroom value and any additional information specified by the PHR configuration. Upon receiving the PHR from the UE, the network node can utilize the reported information to make decisions on resource allocation and/or power control. For example, the network node can use information from the PHR to adjust allocated resources and/or power levels for each UE to facilitate maintaining optimal system performance and avoiding interference issues.

In the CA case, if a transmission occasion is scheduled with parallel transmissions, the UE may determine a first maximum transmission power limit, P_{CMAX} 1, associated with the first CC based on a power class for CA (shown as “powerClass”) and a second maximum transmission power limit, P_{CMAX} 2, associated with the second CC based on the power class for CA. A first PHR reference value (shown as “PHR limit”) associated with the first CC can be determined based on the first maximum transmission power limit and a second PHR reference value associated with the second CC can be determined in based on the second maximum transmission power limit. For example, in some cases, because the respective maximum transmission power limits can be determined based on a power class for CA, the respective PHR limits may be based on the respective maximum transmission power limits and/or the power class for CA. A PHR reference value refers to a PHR value that can be used as a reference. For example, in some cases, the PHR reference value can indicate an amount of power that the UE has available (and/or is likely to have available). In some cases, a PHR reference value can be a PHR 0 decibel (dB) limit, which can indicate a maximum transmission power of a UE in a CA scenario and/or a maximum amount of power available to the UE in the CA scenario.

If the transmission occasion is scheduled with parallel transmissions, the UE can determine a first maximum transmission power limit, P_{CMAX} 1, associated with the first CC based on a power class for CA (shown as “powerClass”). The UE can determine a second maximum transmission power limit, P_{CMAX} 2, associated with the second CC based on the power class for CA. In conjunction with determining the first maximum transmission power limit (e.g., during an operation for determining the first maximum transmission power limit), the UE can determine a first PHR reference value associated with the first CC. Similarly, in conjunction with determining the second maximum transmission power limit P_{CMAX} 2, the UE can determine a second PHR reference. In some cases, the respective PHR limits (for each CC) can be based on the respective maximum transmission power limits and/or the power class for CA. The UE can determine, based on the P_{CMAX} 1 and the PHR limit 1, a first transmission power and/or, based on the P_{CMAX} 2 and the PHR limit 2, a second transmission power.

According to one example, if the transmission occasion is scheduled with only one communication and/or with two or more non-parallel communications, the UE may determine the first maximum transmission power limit, Pcmax1, based on a first per-band UE power class (e.g., “UE PBPowerClass 1”) and a first per band per-band-combination UE power class (e.g., “UE PBPBCPowerClass 1,” such as, e.g., a first ue-PowerClassPerBandPerBC-17”). A per-band power class is a power class (e.g., a specified maximum transmission power limit) that applies to a specific band (CC). A per band per-band-combination power class is a power class (e.g., a specified maximum transmission power limit) that applies to a specific band (CC) of a combination of bands (CCs). Similarly, the UE may determine, the second maximum transmission power limit, Pcmax2, based on a second per-band UE power class (shown as “UE PBPowerClass 2”) and a per band per-band-combination UE power class (shown as “UE PBPBCPowerClass 2”). The UE may determine the PHR limit 1 based on the first per-band UE power class and the first per band per-band-combination UE power class. Similarly, the UE may determine a second PHR reference value (shown as “PHR limit 2”) associated with the second CC, as part of the operation (e.g., in conjunction with determining Pcmax2). In some cases, for example, the PHR limit 2 may be determined based on a second per-band UE power class (shown as “2nd ue-PowerClass”) and a second per band per-band-combination UE power class (shown as “2nd ue-PowerClassPerBandPerBC-17”).

In some cases, to facilitate scheduling by the network node and/or appropriate resource allocation for reception at the network node, the UE can declare a power class (of the UE) with one or more capabilities (e.g., via UE capability information and/or a PHR report). UE capability information may include information provided by the UE that indicates one or more capabilities of the UE for supporting one or more features. For example, the UE capability information may indicate power classes supported by the UE, that the UE supports CA, and/or that the UE supports a certain type of PHR calculation, among other examples. The one or more capabilities may include, for example, the per-band UE power class(s), the per band per-band-combination UE power class(s), and/or the power class for CA, among other examples. In some cases, the UE 402 can use a higher limit per band per-band-combination power class to indicate larger combined power limit when different power classes are declared between two bands in CA.

For example, in some cases, the UE may declare a power class of PC2 associated with the first CC, a power class of PC3 associated with the second CC, and a power class of PC3 associated with CA. In some cases, even though CC1 (e.g., a first band) and CC2 (e.g., a second band) have the same output power capability in both cases, the UE can choose to declare PC3 or PC2 in CA. In one or more examples, the UE can clarify maximum power associated with individual bands using a per band per-band-combination UE power class.

As described above, a wireless communication standard may specify a CA power class. However, in some cases, wireless communication standards may be ambiguous regarding when the power class for CA is applied. Because the power class for CA may restrict transmission power, resolving this ambiguity may result in more efficient and/or effective communications. Moreover, in some cases, the UE may declare a first power class associated with a CC, but end up using a second power class for the CC (e.g., as a consequence of using the power class for CA instead). For example, the power class for CA might be used 1) when both CCs are configured, 2) when both CCs are activated, or 3) when both CCs are scheduled. In some cases, a wireless communication standard may specify that the power class for CA is to be used 1) when both CCs are configured. However, in some cases, although two CCs may be configured, the network node may only allocate resources (e.g., schedule) for communications on one CC or the other for a given transmission occasion. In some cases, therefore, option 3 (the case in which the power class for CA is used when both CCs are scheduled) may be the most efficient of the three, as there may be no need to restrict the power if only one band is granted a transmission.

In some cases, if option 3 is adopted, a PHR reference value for a CC can change depending on transmissions on the other CC. When the PHR reference value for a CC is dependent on another CC, transmissions on the other CC that exceed a power class associated with CA can cause confusion from the network node perspective. The confusion may occur because when, for example, only one CC is observed (e.g., by a transmission reception point (TRP) associated with that one CC), the PHR can seem to be changing sporadically. In other words, there appears to be an instability in the PHR in one CC because a network node lacks information indicating changes in transmission power in another CC from which the PHR is derived. If the network node is provided more accurate information associated with a UE power class (e.g., the power class that the UE would actually use) and a stable PHR (e.g., a PHR that does not appear to change in one CC as a result of dependency on transmissions in another CC), the network node may be able to more effectively and/or efficiently allocate resources for the actual transmission.

Some aspects of the techniques described herein may facilitate providing a stable PHR reference value for carrier aggregation. A stable PHR reference value is a PHR reference value that does not change as a function of a change in the type of resource allocation (e.g., the stable PHR reference value is the same for a single CC transmission as it is for overlapping CA transmissions on multiple CCs and/or non-overlapping CA transmissions on multiple CCs). For example, some aspects may include separating the calculation of the PHR reference value from the calculation of the maximum transmission power. In some aspects, separating the calculation of the PHR reference value from the calculation of the maximum transmission power may enable the PHR reference value to be determined without regard to the power class for CA. This separation may result in a PHR reference value, for a CC, that is stable (e.g., has the same value) regardless of whether the power class for CA is being used in the determination of the maximum transmission power or not. As a result, some aspects may enhance the predictability of the transmission power, since the transmission power is limited by the PHR reference value. In some aspects, a UE may determine the PHR reference value based on the per-band UE power class and the per band per-band-combination UE power class. For example, the UE may determine the PHR reference value as a maximum of the two power classes associated with the CC. In some cases, the PHR reference value for a CC may be determined based on a per band UE power class and a per band per-band-combination UE power class regardless of whether the network node schedules overlapping or non-overlapping transmissions for a transmission occasion. In this way, some aspects may facilitate providing a stable PHR reference value, thereby improving the predictability of UE transmission power determinations with regard to two or more CCs in a CA configuration, resulting in more efficient resource scheduling and more effective reception, at the network, of UE transmissions, which may positively impact network and/or device performance.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

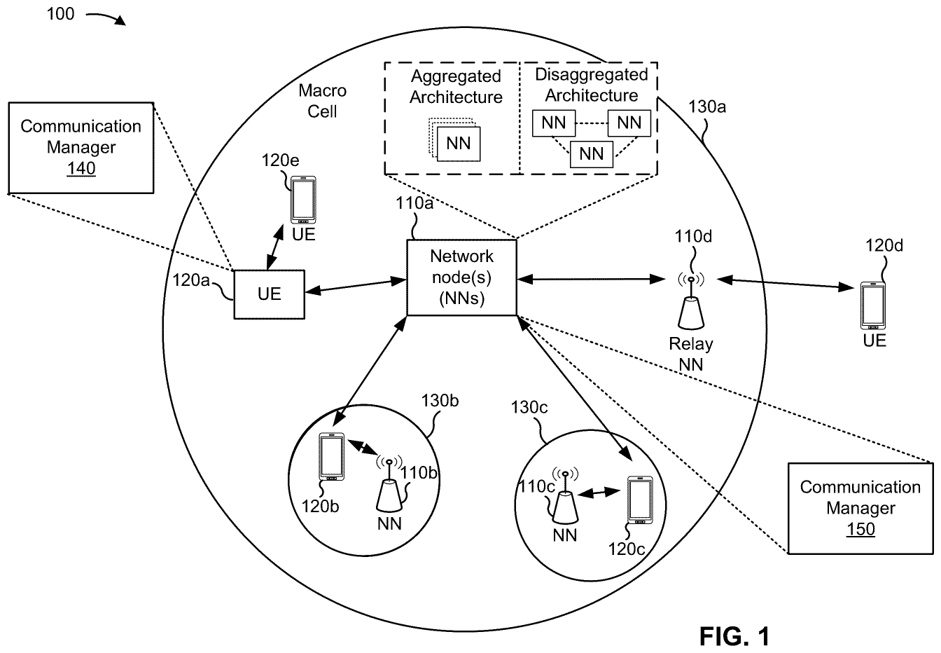

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In one or more examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may receive configuration information indicative of a carrier aggregation configuration associated with a first CC and a second CC; receive scheduling information indicative of at least one scheduled transmission during a transmission occasion associated with at least one of the first CC or the second CC; and transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit configuration information indicative of a carrier aggregation configuration associated with a first CC and a second CC; transmit scheduling information indicative of at least one scheduled transmission during a transmission occasion associated with at least one of the first CC or the second CC; and receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit. Additionally, or alternatively, the communication manager 150 may perform one or more other operations described herein.

As indicated above, FIG. 1 is provided as an example. Other examples may differ from what is described with regard to FIG. 1.

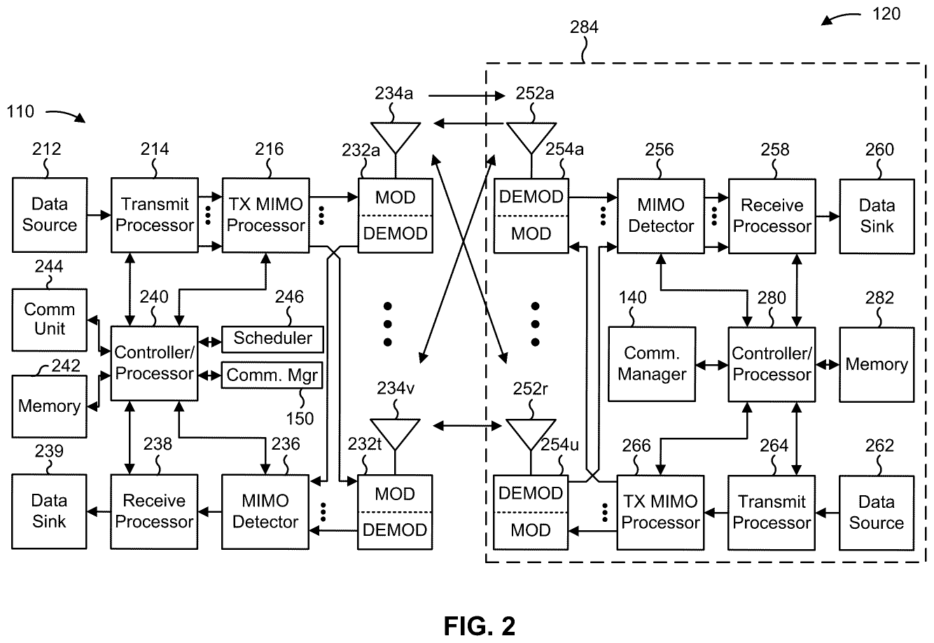

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

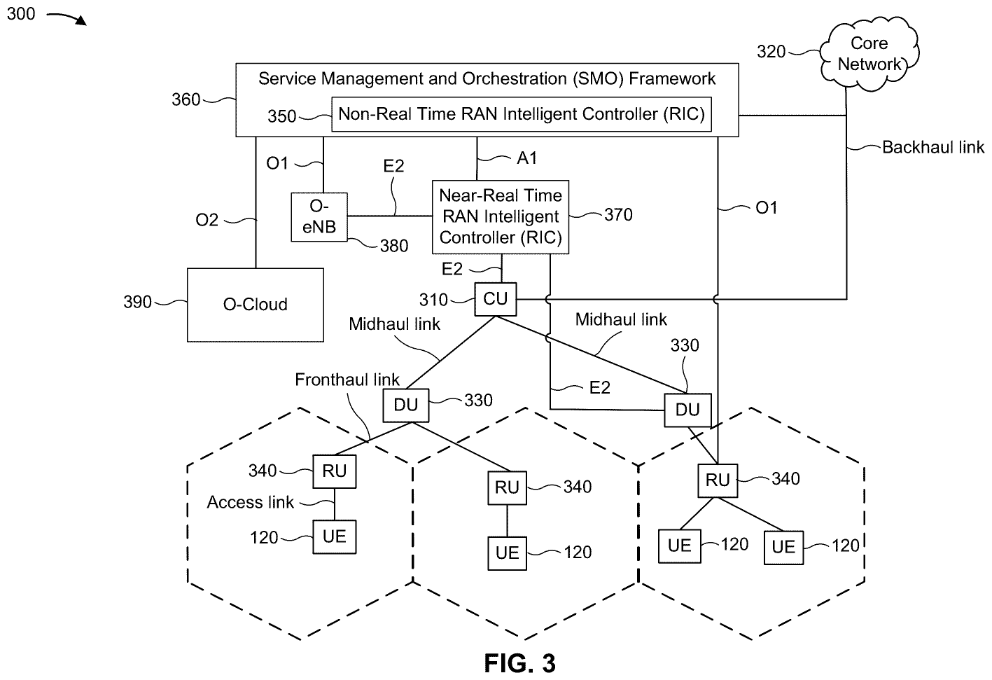

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

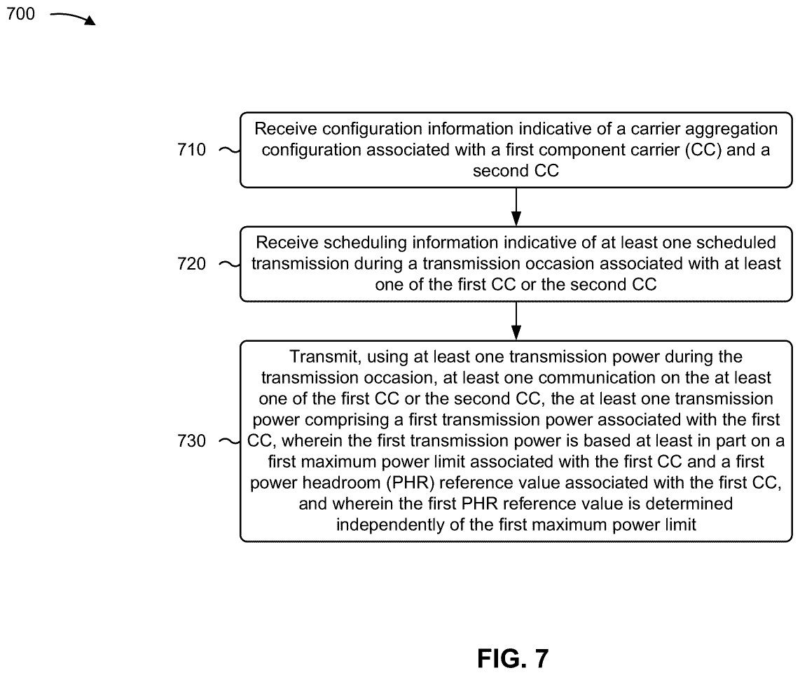

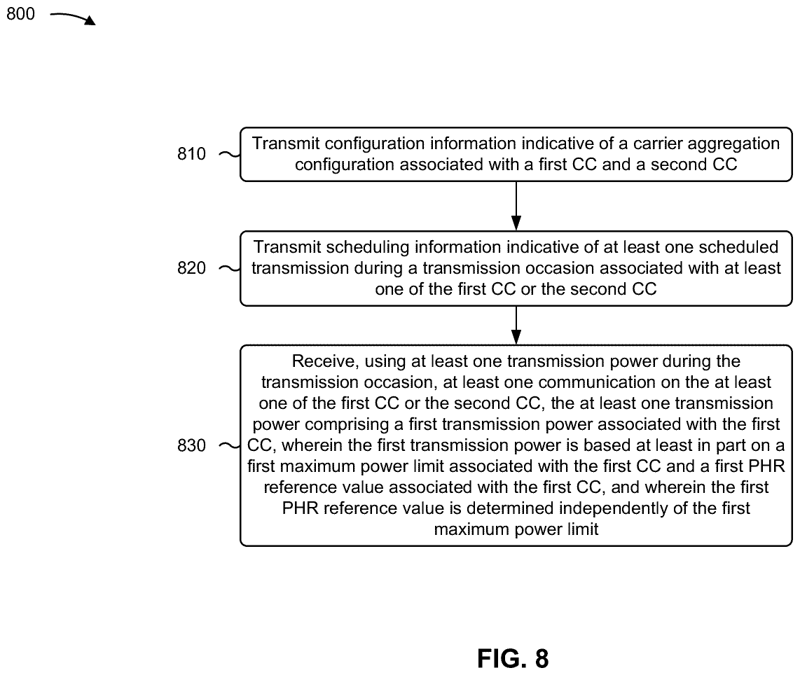

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with stable PHR reference for carrier aggregation, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, a UE (e.g., the UE 120) includes means for receiving configuration information indicative of a carrier aggregation configuration associated with a first CC and a second CC; means for receiving scheduling information indicative of at least one scheduled transmission during a transmission occasion associated with at least one of the first CC or the second CC; and/or means for transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting configuration information indicative of a carrier aggregation configuration associated with a first CC and a second CC; means for transmitting scheduling information indicative of at least one scheduled transmission during a transmission occasion associated with at least one of the first CC or the second CC; and/or means for receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Carrier aggregation is a technology that enables two or more component carriers (CCs, sometimes referred to as carriers) to be combined (e.g., into a single channel) for a single UE to enhance data capacity. Carriers can be combined in the same or different frequency bands. Additionally, or alternatively, contiguous or non-contiguous carriers can be combined. A network node may configure carrier aggregation for a UE, such as in a radio resource control (RRC) message, downlink control information (DCI), and/or another signaling message.

In some aspects, carrier aggregation may be configured in an intra-band contiguous mode where the aggregated carriers are contiguous to one another and are in the same band. In some aspects, carrier aggregation may be configured in an intra-band non-contiguous mode where the aggregated carriers are non-contiguous to one another and are in the same band. In some aspects, carrier aggregation may be configured in an inter-band non-contiguous mode where the aggregated carriers are non-contiguous to one another and are in different bands.

In carrier aggregation, a UE may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

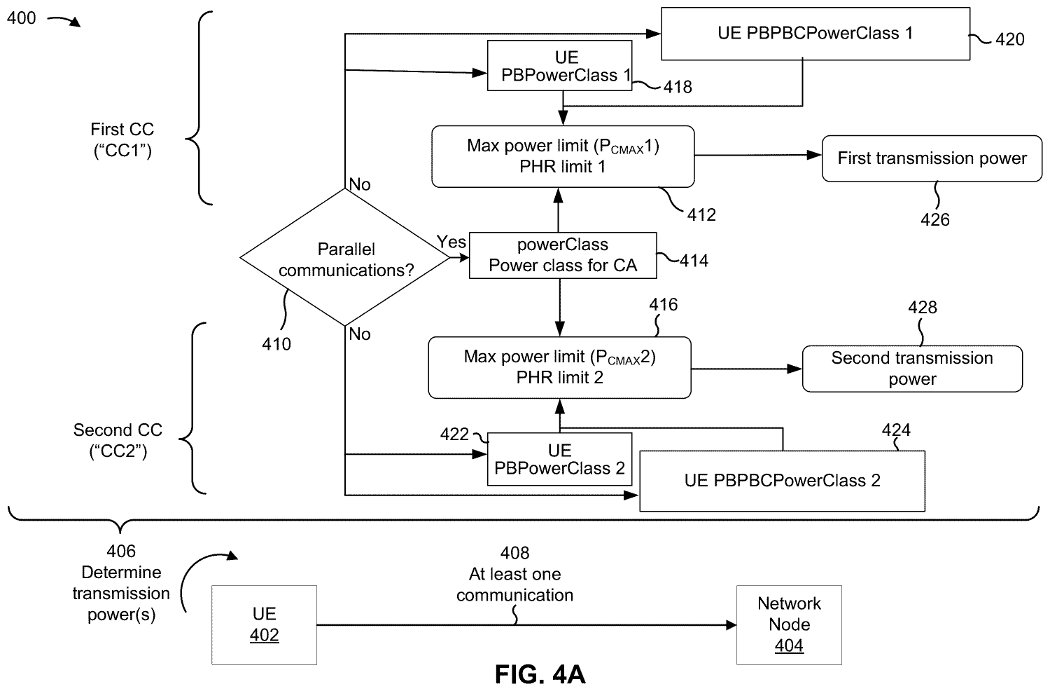

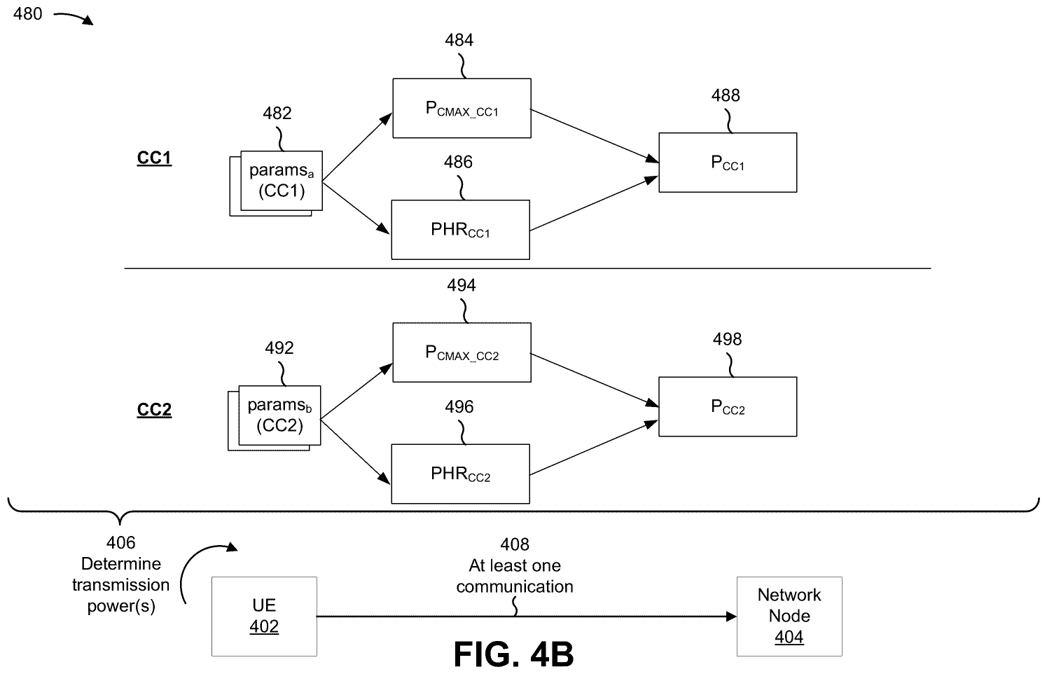

FIGS. 4A and 4B are diagrams illustrating examples 400/480 associated with determining power transmissions in association with CA configurations, in accordance with the present disclosure. As shown in FIG. 4A, a UE 402 and a network node 404 may communicate with one another.

As shown by reference number 406, the UE 402 may determine transmission power(s) (e.g., one or more transmission powers) and, as shown by reference number 408, the UE 402 may transmit at least one communication. For example, the UE 402 may transmit the at least one communication using the determined transmission power(s).

In some cases, for example, the UE 402 may be configured with a carrier aggregation (CA) configuration indicative of a first component carrier (CC) and a second CC. The first CC may be associated with a first band and the second CC may be associated with a second band. As shown by reference number 410, the UE 402 may be configured to determine whether scheduling information indicates that there are to be parallel transmissions during a transmission occasion. For example, parallel transmissions may be two or more transmissions that are scheduled to be transmitted within a same transmission occasion and that at least partially overlap in a time domain. Non-parallel transmissions may be two or more transmissions that do not at least partially overlap in the time domain.

If the transmission occasion is scheduled with parallel transmissions, the UE 402 may determine, using an operation 412, a first maximum transmission power limit, Pcmax1, associated with the first CC based on a power class for CA (shown as “powerClass”) 414. The UE 402 may determine, using an operation 416, a second maximum transmission power limit, PCMAX2 (which may also be referred to as “Pcmax2” or “P_{CMAX}_CC2”), associated with the second CC based on the power class for CA 414. The UE 402 may determine a first PHR reference value (shown as “PHR limit 1” and which may also be referred to as a “PHR_{CC1}”) associated with the first CC as part of the operation 412 (e.g., in conjunction with determining P_{CMAX1}, which may also be referred to as “Pcmax1” or “P_{CMAX_CC1}”) and a second PHR reference value (shown as “PHR limit 2” and which may also be referred to as “PHR_{CC2}”) associated with the second CC as part of the operation 416. In some cases, the respective PHR limits may be based on the respective maximum transmission power limits and/or the power class for CA 414. The UE 402 may determine, based on the Pcmax1 and the PHR limit 1, a first transmission power 426 and/or, based on the Pcmax2 and the PHR limit 2, a second transmission power 428.

If the transmission occasion is scheduled with only one communication and/or with two or more non-parallel communications, the UE 402 may determine, using the operation 412, the first maximum transmission power limit, Pcmax1, based on a first per-band UE power class (shown as “1st ue-PowerClass”) 418 and a first per band per-band-combination UE power class (shown as “1st ue-PowerClassPerBandPerBC-17”) 420. Similarly, the UE 402 may determine, using the operation 416, the second maximum transmission power limit, Pcmax2, based on a second per-band UE power class 422 (shown as “2nd ue-PowerClass”) and a per band per-band-combination UE power class 424 (shown as “2nd ue-PowerClassPerBandPerBC-r17”). The UE 402 may determine the PHR limit 1 based on the first per-band UE power class 418 and the first per band per-band-combination UE power class 420. Similarly, the UE 402 may determine a second PHR reference value (shown as “PHR limit 2”) associated with the second CC, as part of the operation 416 (e.g., in conjunction with determining Pcmax2). In some cases, for example, the PHR limit 2 may be determined based on a second per-band UE power class (shown as “2nd ue-PowerClass”) 422 and a second per band per-band-combination UE power class (shown as “2nd ue-PowerClassPerBandPerBC-17”) 424.

As shown in FIG. 4B, the UE 402 may determine the first transmission power (shown as “P_{CC1}”) and the second transmission power (shown as “P_{CC2}”) for a first CC (shown as “CC1”) and a second CC (shown as “CC2”), respectively. Each transmission power is derived from, among other parameters, a respective maximum transmit power (P_{CMAX}) and a respective power headroom limit (PHR), as described above. Similarly, the maximum transmit power and the respective power headroom limit are derived from a set of parameters (“params”), as described above. For example, with respect to CC1, the UE 402 may use a set of parameters, paramsₐ 482, as described above, to determine a maximum transmit power P_{CMAX_CC1} 484 and a power headroom limit PHR_{CC1} 486 (e.g., from which the UE 402 may determine a first transmission power P_{CC1} 488). Similarly, with respect to CC2, the UE 402 may use a set of parameters, params_{b} 492, to determine a maximum transmit power P_{CMAX_CC2} 494 and a power headroom limit PHR_{CC2} 496 (e.g., from which the UE 402 may determine a second transmission power P_{CC2} 498).

As described above, if a transmission occasion is scheduled with parallel transmissions, the first maximum transmission power limit, associated with the first CC, is determined, by the UE 402, based on a power class for CA. In other words, the UE 402 determines P_{CMAX_CC1} 484 from paramsₐ 482. Similarly, as described above, the UE 402 determines a first PHR reference value, associated with the first CC, in conjunction with determining P_{CMAX_CC1}. In other words, the UE 402 determines PHR_{CC1} 486 from at least one of the same paramsₐ 482 from which the P_{CMAX_CC1} 484 is determined. Accordingly, P_{CC1} is derived based on deriving P_{CMAX_CC1} 484 and PHR_{CC1} 486 from the paramsₐ 482. A similar operation occurs on CC2 with respect to params_{b} 492, P_{CMAX_CC2} 494, PHR_{CC2} 496, and P_{CC2} 498, as described above.

In some cases, to facilitate scheduling by the network node 404 and/or appropriate resource allocation for reception at the network node 404, the UE 402 can declare it power class with one or more capabilities (e.g., via UE capability information and/or a PHR report). The one or more capabilities may include, for example, the per-band UE power class(s), the per band per-band-combination UE power class(s), and/or the power class for CA, among other examples. In some cases, the UE 402 can use a higherPowerLimit-r17 per band combination to indicate larger combined power limit when different power classes are declared between two bands in CA.

For example, in some cases, the UE 402 may declare a power class of PC2 associated with the first CC, a power class of PC3 associated with the second CC, and a power class of PC3 associated with CA. In another case, for example, the UE 402 may declare a power class of PC2 associated with the first CC, a power class of PC3 associated with the second CC, and a power class of PC3 associated with CA. In some cases, even though CC1 (e.g., a first band) and CC2 (e.g., a second band) have the same output power capability in both cases, the UE 402 can choose to declare PC3 or PC2 in CA since PC2 can fallback to PC3. In one or more examples, the UE 402 can clarify maximum power associated with individual bands using ue-PowerClassPerBandPerBC-r17. For example, whether the maximum output power capability associated with CC1 is 23 or 26 dBm in CA, the ue-PowerClassPerBandPerBC-r17 can be optional to be used.

However, in some cases, wireless communication standards may be ambiguous regarding when the power class for CA is applied. Because the power class for CA may restrict transmission power, resolving this ambiguity may result in more efficient and/or effective communications. Moreover, in some cases, the UE may declare a first power class associated with a CC, but end up using a second power class for the CC (e.g., as a consequence of using the power class for CA instead). For example, the power class for CA might be used 1) when both CCs are configured, 2) when both CCs are activated, or 3) when both CCs are scheduled. In some cases, a wireless communication standard may specify that the power class for CA is to be used 1) when both CCs are configured. However, in some cases, although two CCs may be configured, the network node 404 may only allocate resources (e.g., schedule) for communications on one CC or the other for a given transmission occasion. In some cases, therefore, option 3 (the case in which the power class for CA is used when both CCs are scheduled) may be the most efficient of the three, as there may be no need to restrict the power if only one band is granted a transmission.

In some cases, if option 3 is adopted in implementation, PHR reference values can change depending on transmissions on the other CC, which can cause confusion from the network node 404 perspective, because, for example, when only one CC is observed, the PHR can seem to be changing sporadically. Accordingly, if the network node 404 had more accurate information associated with the power class that the UE 402 would actually use, the network node 404 may be able to more effectively and/or efficiently allocate resources for the actual transmission.

Some aspects of the techniques described herein may facilitate providing a stable PHR reference value for carrier aggregation. For example, some aspects may include separating the calculation of the PHR reference value from the calculation of the maximum transmission power. In some aspects, separating the calculation of the PHR reference value from the calculation of the maximum transmission power may enable the PHR reference value to be determined without regard to the power class for CA, resulting in a PHR reference value that is stable (e.g., the same) regardless of whether the power class for CA is being used in the determination of the maximum transmission power or not, thereby enhancing the predictability of the transmission power, since the transmission power is limited by the PHR reference value. In some aspects, a UE may determine the PHR reference value based on the per-band UE power class and the per band per-band-combination UE power class. For example, the UE may determine the PHR reference value as a maximum of the two power classes. In some cases, the PHR reference value for a CC may be determined in this manner regardless of whether the network node schedules overlapping or non-overlapping transmissions for a transmission occasion. In this way, some aspects may facilitate providing a stable PHR reference value, thereby improving the predictability of UE transmission power determinations with regard to two or more CCs, resulting in more efficient resource scheduling and more effective reception, at the network, of UE transmissions, which may positively impact network and/or device performance.

As indicated above, FIGS. 4A and 4B are provided as an example. Other examples may differ from what is described with respect to FIGS. 4A and 4B.

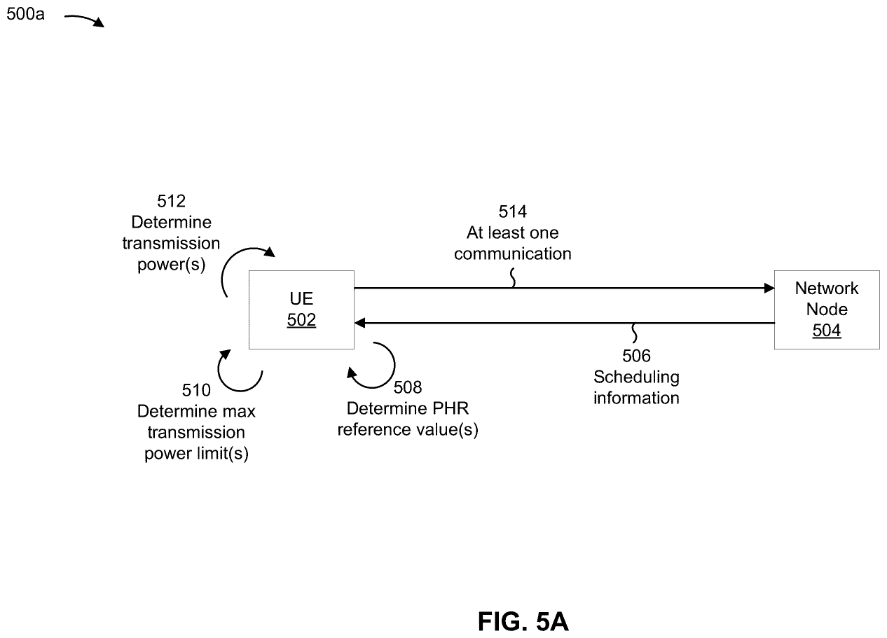

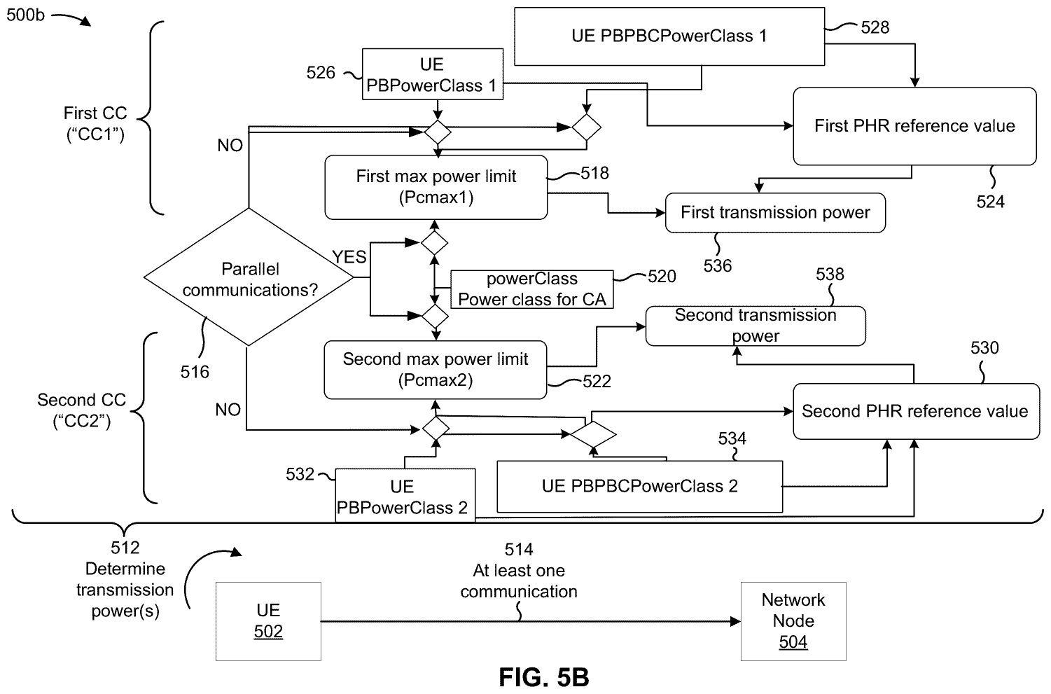

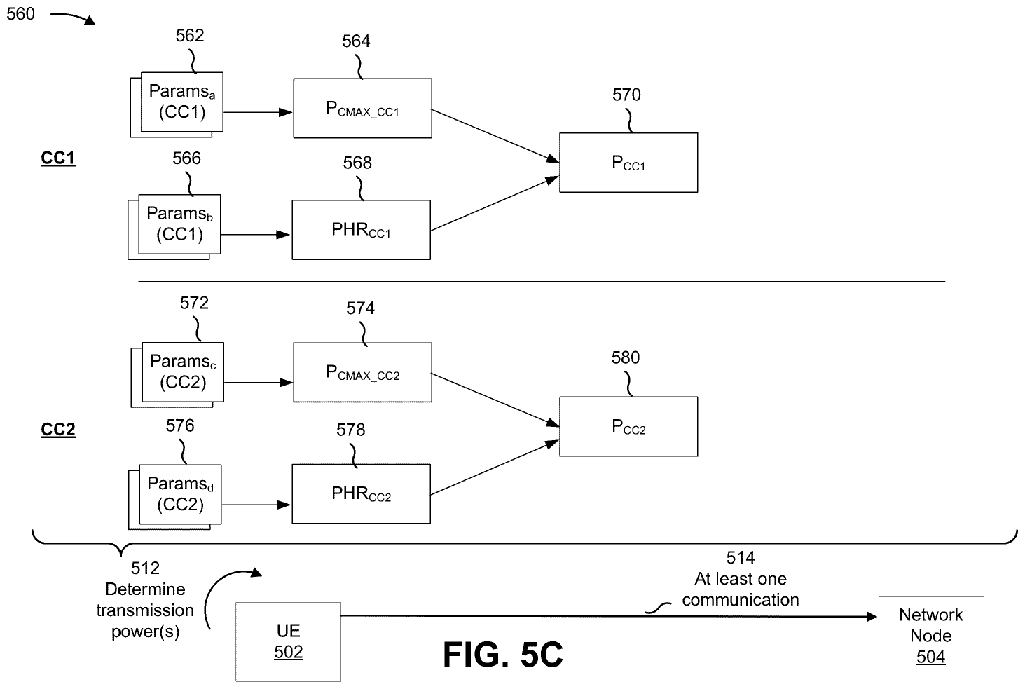

FIGS. 5A-5C are diagrams of examples 500a, 500b, and 560 respectively, associated with stable PHR references for carrier aggregation, in accordance with the present disclosure. As shown in FIG. 5A, a UE 502 and a network node 504 may communicate with one another. In some aspects, the UE 502 and the network node 504 may be part of a wireless network (e.g., wireless communication network 100). In some aspects, the UE 502 may be, be similar to, include, or be included in the UE 402 depicted in FIGS. 4A and 4B, and/or the UE 120 depicted in FIGS. 1-3. In some aspects, the network node 504 may be, be similar to, include, or be included in, the network node 404 depicted in FIGS. 4A and 4B, the network node 110 depicted in FIGS. 1 and 2, and/or one or more components of the disaggregated base station architecture 300 depicted in FIG. 3. In some aspects, the network node 504 may include a first TRP configured to communicate on a first CC and a second TRP configured to communicate on a second CC. The UE 502 and the network node 504 may have established a wireless connection prior to operations shown in FIG. 5.

As shown by reference number 506, the network node 504 may transmit, and the UE 502 may receive, scheduling information. The scheduling information may indicate one or more resources allocated for transmission of one or more uplink communications in a transmission occasion. The scheduling information may indicate a first CC and/or a second CC. For example, in some aspects, the scheduling information may allocate time and/or frequency resources for transmitting a first communication on the first CC and a second communication on the second CC. In some aspects, the allocated resources may be associated with one transmission during the transmission occasion (e.g., one communication on the first CC or the second CC). In some aspects, the allocated resources may be associated with two transmissions during the transmission occasion (e.g., a first communication on the first CC and a second communication on the second CC). In some aspects, the two transmissions may be overlapping transmissions (e.g., the first communication may at least partially overlap the second communication in a time domain) or non-overlapping transmissions (e.g., the first communication may not overlap the second communication in the time domain).

As shown by reference number 508, the UE 502 may determine one or more PHR reference values. For example, the UE 502 may determine a first PHR reference value associated with the first CC and a second PHR reference value associated with the second CC. In some aspects, the UE 502 may determine the one or more PHR reference values independently of determining one or more maximum transmission power limits. In some aspects, for example, the first PHR reference value may be determined based on a first per-band UE power class and a first per band per-band-combination UE power class. For example, in some aspects, the first PHR reference value may be a maximum of the first per-band UE power class and the first per band per-band-combination UE power class. Similarly, in some aspects, the second PHR reference value may be determined based on a second per-band UE power class and a second per band per-band-combination UE power class. For example, in some aspects, the second PHR reference value may be a maximum of the second per-band UE power class and the second per band per-band-combination UE power class.

As shown by reference number 510, the UE 502 may determine one or more maximum transmission power limits (shown as “max transmission power limit(s)”). The one or more maximum transmission powers may include a first maximum transmission power, Pcmax1, associated with the first CC and a second maximum transmission power, Pcmax2, associated with the second CC. The one or more maximum transmission powers may be determined independently of the determination of the one or more PHR reference values. In this way, some aspects may facilitate providing a stable PHR reference value for each CC, even in scenarios involving carrier aggregation. As shown by reference number 512, the UE 502 may determine one or more transmission powers (shown as “transmission power(s)”). For example, in some aspects, the one or more transmission powers may be determined based on the one or more maximum transmission powers and/or the one or more PHR reference values. As shown by reference number 514, the UE 502 may transmit, and the network node 504 may receive, at least one communication. The at least one communication may include a first communication transmitted on the first CC (e.g., using a first determined transmission power) and/or a second communication transmitted on the second CC (e.g., using a second determined transmission power).

The example 500b of FIG. 5B depicts some examples of the determinations described in the context of example 500a of FIG. 5A. As shown by reference number 512, the UE 502 may determine transmission power(s) (e.g., one or more transmission powers) and, as shown by reference number 514, the UE 502 may transmit at least one communication. For example, the UE 502 may transmit the at least one communication using the determined transmission power(s). In some aspects, the example 500 depicts a scenario similar to the scenario depicted by the example 400 of FIG. 4A but in which the UE 502 implements one or more aspects of the techniques described herein associated with a stable PHR reference value for CA.

In some cases, for example, the UE 502 may be configured with a CA configuration indicative of a first CC and a second CC. The first CC may be associated with a first band and the second CC may be associated with a second band. As shown by reference number 516, the UE 502 may be configured to determine whether scheduling information indicates that there are to be parallel transmissions during a transmission occasion. If the transmission occasion is scheduled with parallel transmissions, the UE 502 may determine, using an operation 518, a first maximum transmission power limit, Pcmax1, associated with the first CC based on a power class for CA (shown as “powerClass”) 520. The UE 502 may determine, using an operation 522, a second maximum transmission power limit, Pcmax2, associated with the second CC based on the power class for CA 520.

In the example 500b, the UE 502 may not determine the first PHR reference value as part of the operation 518. Instead, as shown by the operation 524, the UE 502 may determine the first PHR reference value independent of the determination of the first maximum transmission power limit in operation 518. In some aspects, for example, the UE 502 may determine the first PHR reference value based on a first per-band UE power class 526 and a first per band per-band-combination UE power class 528. For example, in some aspects, the first PHR reference value may be equal to the maximum of the first per-band UE power class 526 and the first per band per-band-combination UE power class 528. The PHR reference value determined using operation 524 may be applicable to the first CC whether the UE 502 transmits one or two communications and/or whether the two communications are transmitted in accordance with CA or not.

The UE 502 may determine, using an operation 530, a second PHR reference value (shown as “PHR limit 2”) associated with the second CC. In the example 500b, the UE 502 may not determine the second PHR reference value as part of the operation 522. Instead, as shown by the operation 530, the UE 502 may determine the second PHR reference value independent of the determination of the second maximum transmission power limit in operation 522. In some aspects, for example, the UE 502 may determine the second PHR reference value based on a second per-band UE power class 532 and a second per band per-band-combination UE power class 534. For example, in some aspects, the second PHR reference value may be equal to the maximum of the second per-band UE power class 532 and the second per band per-band-combination UE power class 534. The PHR reference value determined using operation 530 may be applicable to the first CC whether the UE 502 transmits one or two communications and/or whether the two communications are transmitted in accordance with CA or not.

The UE 502 may determine, based on the Pcmax1 and the PHR limit 1, a first transmission power 536 and/or, based on the Pcmax2 and the PHR limit 2, a second transmission power 538.

As shown in FIG. 5C, the UE 502 may determine the first transmission power (shown as “P_{CC1}”) and the second transmission power (shown as “P_{CC2}”) for a first CC (shown as “CC1”) and a second CC (shown as “CC2”), respectively. Each transmission power is derived from, among other parameters, a respective maximum transmit power (P_{CMAX}) and a respective power headroom limit (PHR), as described above. Similarly, the maximum transmit power and the respective power headroom limit are derived from a set of parameters (“params”), as described above. For example, with respect to CC1, the UE 502 may use a first set of parameters, paramsₐ 562, as described above, to determine a maximum transmit power P_{CMAX_CC1} 564 and a second set of parameters, params_{b} 566 to determine a power headroom limit PHR_{CC1} 568 (e.g., from which the UE 502 may determine a first transmission power P_{CC1} 570). Similarly, with respect to CC2, the UE 502 may use a third set of parameters, params_{c} 572, to determine a maximum transmit power P_{CMAX_CC2} 574 and a fourth set of parameters, paramsₐ 576, to determine a power headroom limit PHR_{CC2} 578 (e.g., from which the UE 502 may determine a second transmission power P_{CC2} 580).

As described above, the first maximum transmission power limit, associated with the first CC, is determined, by the UE 502, in a first operation and based on a power class for CA. In other words, the UE 502 determines P_{CMAX_CC1} 564 from paramsₐ 562. Similarly, as described above, the UE 502 determines a first PHR reference value, associated with the first CC, in a separate operation and independent from determining P_{CMAX}_CC1. In other words, the UE 502 determines PHR_{CC1} 568 from the params_{b} 566 separately from the paramsₐ 562 from which the P_{CMAX_CC1} 564 is determined. Accordingly, P_{CC1} is derived based on deriving P_{CMAX_CC1} 564 and PHR_{CC1} 568 independently from different parameter sets (e.g., in different operations). A similar set of independent operations occurs on CC2 with respect to params_{c} 572 and P_{CMAX_CC2} 574, paramsₐ 576 and PHR_{CC2} 578, and P_{CC2} 580, as described above.

As indicated above, FIGS. 5A-5C are provided as examples. Other examples may differ from what is described with regard to FIGS. 5A-5C.

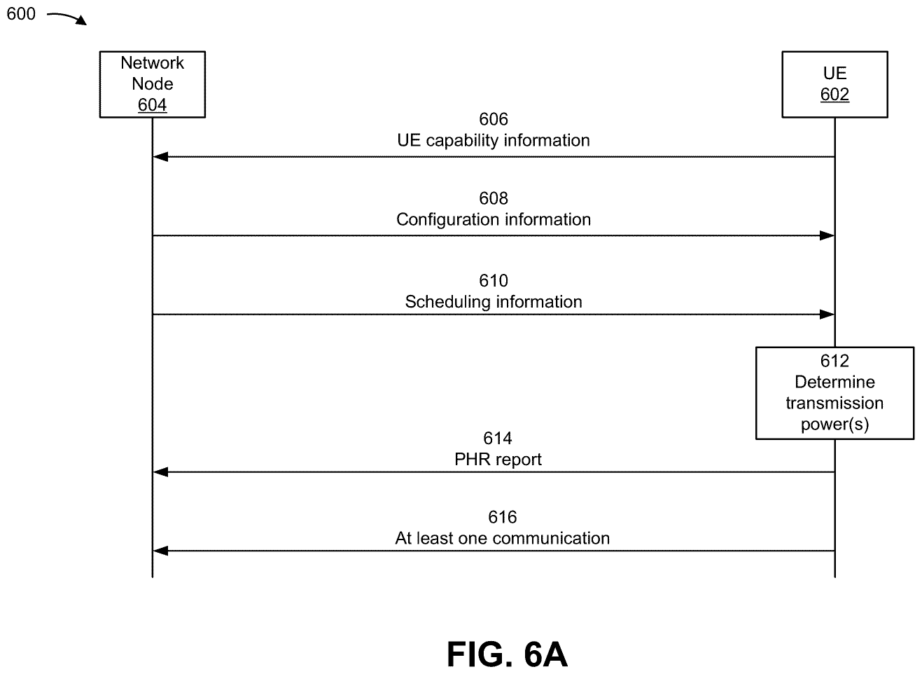

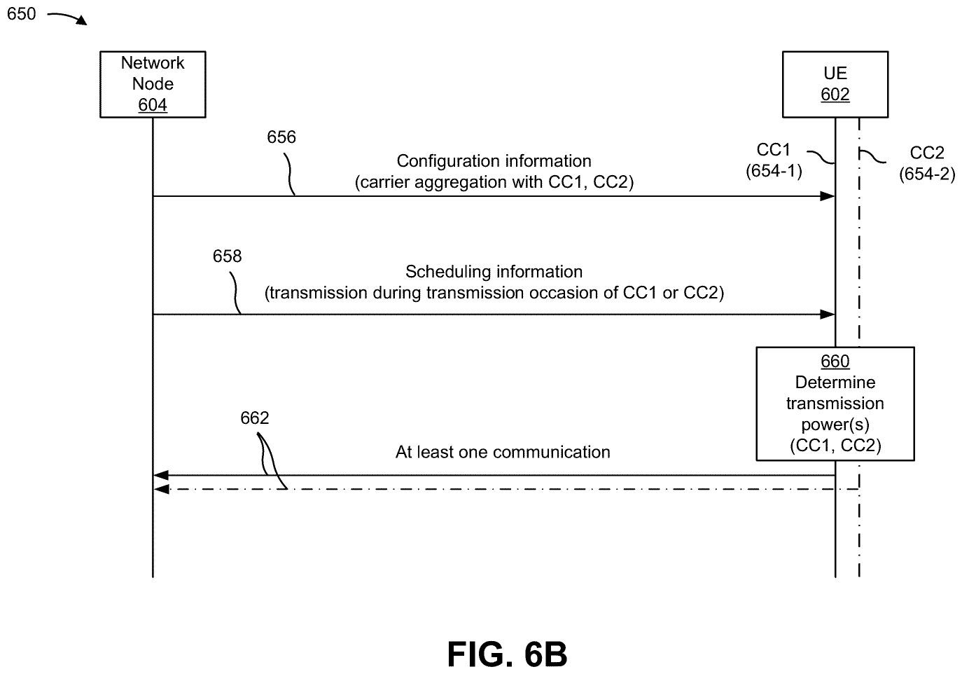

FIGS. 6A and 6B are diagrams of examples 600 and 650, respectively, associated with stable PHR references for carrier aggregation, in accordance with the present disclosure. As shown in FIG. 6A, a UE 602 and a network node 604 may communicate with one another. In some aspects, the UE 602 and the network node 604 may be part of a wireless network (e.g., wireless communication network 100). In some aspects, the UE 602 may be, be similar to, include, or be included in the UE 502 depicted in FIG. 5, the UE 402 depicted in FIGS. 4A and 4B, and/or the UE 120 depicted in FIGS. 1-3. In some aspects, the network node 604 may be, be similar to, include, or be included in, the network node 504 depicted in FIG. 5, the network node 404 depicted in FIGS. 4A and 4B, the network node 110 depicted in FIGS. 1 and 2, and/or one or more components of the disaggregated base station architecture 300 depicted in FIG. 3. In some aspects, actions described as being performed by the network node 604 may be performed by multiple different network nodes 604. For example, configuration actions may be performed by a first network node 604 (e.g., a CU and/or a DU), and radio communication actions may be performed by a second network node 604 (e.g., a DU and/or an RU). In some aspects, the network node 604 may include a first transmission reception point (TRP) configured to communicate on a first CC and a second TRP configured to communicate on a second CC. The UE 602 and the network node 604 may have established a wireless connection prior to operations shown in FIG. 6A.

As shown by reference number 606, the UE 602 may transmit (directly or via one or more other UEs and/or network nodes), and the network node 604 may receive, UE capability information. In some aspects, the UE capability information may indicate a UE capability of supporting carrier aggregation. In some aspects, the UE capability information may be indicative of a capability for supporting a stable PHR for carrier aggregation, as described herein.

As shown by reference number 608, the network node 604 may transmit (or send) (directly or via one or more other network nodes), and the UE 602 may receive (or obtain), configuration information. In some aspects, the UE 602 may receive the configuration information via RRC signaling, one or more MAC-CEs, and/or DCI, among other examples. In some aspects, the configuration information may include an indication of one or more configuration parameters (e.g., already known to the UE 602 and/or previously indicated by the network node 604 or other network device) for selection by the UE 602, and/or explicit configuration information for the UE 602 to use to configure the UE 602, among other examples. In some aspects, the configuration information may include any number of communications that provide configuration information. The configuration information may be, or include, one or more configurations, parts of one or more configurations, parameter values associated with one or more configurations (e.g., associated with configured parameters), and/or any other type of information that may be used to configure the UE 602 with a first CC and a second CC in the context of a carrier aggregation configuration, among other examples. For example, the configuration information may include a carrier aggregation configuration that indicates the first CC and the second CC. In some aspects, the UE 602 may configure itself, based at least in part on receiving the configuration information. In some aspects, the UE 602 may be configured to perform one or more operations described herein based at least in part on the configuration information.

As shown by reference number 610, the network node 604 may transmit (or send) (directly or via one or more other network nodes), and the UE 602 may receive (or obtain), scheduling information. The scheduling information may be carried, for example, via DCI, and may indicate time and/or frequency resources for transmission of one or more uplink signals by the UE 602 to the network node 604. In some examples, the scheduling information may indicate that the UE 602 is to transmit one communication during a transmission occasion. In some examples the scheduling information may indicate that the UE 602 is to transmit two communications during the transmission occasion. For example, in some aspects, the scheduling information may schedule overlapping communications and/or non-overlapping communications. The scheduled communications may be associated with a first CC and/or a second CC.

As shown by reference number 612, the UE 602 may determine one or more transmission powers (shown as “transmission power(s)”) to be used to transmit the scheduled communication or communications. For example, the UE 602 may determine a first transmission power associated with the first CC. The UE 602 may determine the first transmission power based at least in part on a first maximum transmission power limit, P_{CMAX}, associated with the first CC and a first PHR reference value associated with the first CC. In some aspects, the UE 602 may determine the PHR reference value independently of the first maximum transmission power limit.

In some aspects, for example, the first PHR reference value may be a maximum of a first per band UE power class and a first per band per-band-combination UE power class associated with the carrier aggregation configuration. In some aspects, the at least one scheduled communication includes, during the transmission occasion, only a first communication associated with the first CC. In some aspects, based on the at least one scheduled communication including only the first transmission during the transmission occasion, the first maximum transmission power limit may be based on a first per band UE power class and a first per band per-band-combination UE power class.

In some aspects, the at least one scheduled transmission may include two parallel transmissions during the transmission occasion, and the first maximum transmission power limit may be based at least in part on a carrier aggregation power class. The at least one transmission power may include a second transmission power associated with the second CC. The second transmission power may be based on a second maximum transmission power limit based at least in part on the carrier aggregation power class.

In some aspects, the at least one scheduled transmission may include two non-parallel transmissions during the transmission occasion, and the first maximum transmission power limit may be based at least in part on a first per-band UE power class. The at least one transmission power may further include a second transmission power associated with the second CC. The second transmission power may be based at least in part on a second PHR reference value associated with the second CC. The second PHR reference value may include a maximum of a second per-band UE power class and a second per band per-band-combination UE power class associated with carrier aggregation. In some aspects, the second transmission power may be based on a second maximum transmission power limit. The second maximum transmission power limit may be based at least in part on a second per-band UE power class. The second PHR reference value may be determined independently of the second maximum transmission power limit.

As shown by reference number 614, the UE 602 may transmit (or send) (directly or via one or more other network nodes), and the network node 604 may receive (or obtain), a PHR report. The PHR report may indicate, based on the scheduling information, the first PHR reference value and/or the second PHR reference value, among other examples.

As shown by reference number 616, the UE 602 may transmit (or send) (directly or via one or more other network nodes), and the network node 604 may receive (or obtain), the at least one communication. In some aspects, the at least one communication may be transmitted using the first transmission power and/or the second transmission power. Because the first transmission power and the second transmission power may be based on the reported PHR reference value, the network node 604 may be able to appropriately schedule and/or receive the at least one communication. In this regard, in some aspects, the network node 604 may transmit, and the UE 602 may receive, the scheduling information subsequent to the UE 602 transmitting the PHR report to the network node 604.

As shown in FIG. 6B, a UE 602 and a network node 604 may communicate with one another across a set of carriers CC1, shown by reference number 654-1, and CC2, shown by reference number 654-2. For example, the network node 604 may include a first TRP configured to communicate on a first CC 654-1 and a second TRP configured to communicate on a second CC 654-2. The UE 602 and the network node 604 may have established a wireless connection prior to operations shown in FIG. 6B.

As shown by reference number 656, the network node 604 may transmit (or send) (directly or via one or more other network nodes), and the UE 602 may receive (or obtain), configuration information, as described above. For example, the UE 602 may receive the configuration information via RRC signaling, one or more MAC-CEs, and/or DCI, among other examples. In some aspects, the configuration information may include an indication of one or more configuration parameters (e.g., already known to the UE 602 and/or previously indicated by the network node 604 or other network device) for selection by the UE 602, and/or explicit configuration information for the UE 602 to use to configure the UE 602, among other examples. In some aspects, the configuration information may include any number of communications that provide configuration information. The configuration information may be, or include, one or more configurations, parts of one or more configurations, parameter values associated with one or more configurations (e.g., associated with configured parameters), and/or any other type of information that may be used to configure the UE 602 with a first CC 654-1 and a second CC 654-2 in the context of a carrier aggregation configuration, among other examples. For example, the configuration information may include a carrier aggregation configuration that indicates the first CC 654-1 and the second CC 654-2. In some aspects, the UE 602 may configure itself, based at least in part on receiving the configuration information. In some aspects, the UE 602 may be configured to perform one or more operations described herein based at least in part on the configuration information.

As shown by reference number 658, the network node 604 may transmit (or send) (directly or via one or more other network nodes), and the UE 602 may receive (or obtain), scheduling information. The scheduling information may be carried, for example, via DCI, and may indicate time and/or frequency resources for transmission of one or more uplink signals by the UE 602 to the network node 604. In some examples, the scheduling information may indicate that the UE 602 is to transmit one communication during a transmission occasion. In some examples the scheduling information may indicate that the UE 602 is to transmit two communications during the transmission occasion. For example, in some aspects, the scheduling information may schedule overlapping communications and/or non-overlapping communications. The scheduled communications may be associated with a first CC 654-1 and/or a second CC 654-2.

As shown by reference number 660, the UE 602 may determine one or more transmission powers (shown as “transmission power(s)”) to be used to transmit the scheduled communication or communications. For example, the UE 602 may determine a first transmission power associated with the first CC 654-1. The UE 602 may determine the first transmission power based at least in part on a first maximum transmission power limit, P_{CMAX}, associated with the first CC 654-1 and a first PHR reference value associated with the first CC 654-1. In some aspects, the UE 602 may determine the PHR reference value independently of the first maximum transmission power limit.

In some aspects, for example, the first PHR reference value may be a maximum of a first per band UE power class and a first per band per-band-combination UE power class associated with the carrier aggregation configuration. In some aspects, the at least one scheduled communication includes, during the transmission occasion, only a first communication associated with the first CC 654-1. In some aspects, based on the at least one scheduled communication including only the first transmission during the transmission occasion, the first maximum transmission power limit may be based on a first per band UE power class and a first per band per-band-combination UE power class.

In some aspects, the at least one scheduled transmission may include two parallel transmissions during the transmission occasion, and the first maximum transmission power limit may be based at least in part on a carrier aggregation power class. The at least one transmission power may include a second transmission power associated with the second CC 654-2. The second transmission power may be based on a second maximum transmission power limit based at least in part on the carrier aggregation power class.

In some aspects, the at least one scheduled transmission may include two non-parallel transmissions during the transmission occasion, and the first maximum transmission power limit may be based at least in part on a first per-band UE power class. The at least one transmission power may further include a second transmission power associated with the second CC 654-2. The second transmission power may be based at least in part on a second PHR reference value associated with the second CC 654-2. The second PHR reference value may include a maximum of a second per-band UE power class and a second per band per-band-combination UE power class associated with carrier aggregation. In some aspects, the second transmission power may be based on a second maximum transmission power limit. The second maximum transmission power limit may be based at least in part on a second per-band UE power class. The second PHR reference value may be determined independently of the second maximum transmission power limit.

As shown by reference number 662, the UE 602 may transmit (or send) (directly or via one or more other network nodes), and the network node 604 may receive (or obtain), the at least one communication. For example, the UE 602 may transmit and the network node 604 may receive on the first CC 654-1 and/or the second CC 654-2. In some aspects, the at least one communication may be transmitted using the first transmission power and/or the second transmission power. Because the first transmission power and the second transmission power may be based on the reported PHR reference value, the network node 604 may be able to appropriately schedule and/or receive the at least one communication. In this regard, in some aspects, the network node 604 may transmit, and the UE 602 may receive, the scheduling information subsequent to the UE 602 transmitting the PHR report to the network node 604.

As indicated above, FIGS. 6A and 6B are provided as examples. Other examples may differ from what is described with respect to FIGS. 6A and 6B.

FIG. 7 is a diagram illustrating an example process 700 performed, for example, at a UE or an apparatus of a UE, in accordance with the present disclosure. Example process 700 is an example where the apparatus or the UE (e.g., UE 602) performs operations associated with stable PHR reference values for carrier aggregation.

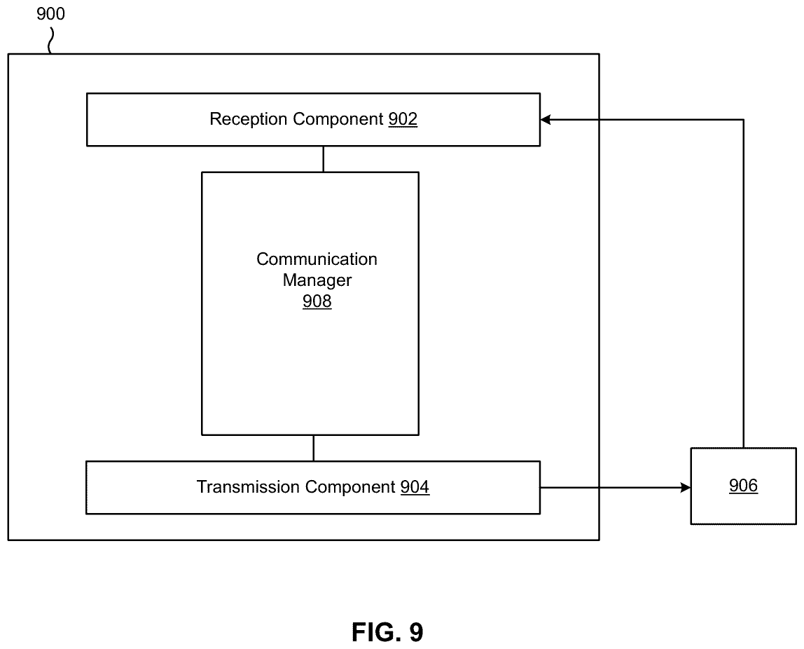

As shown in FIG. 7, in some aspects, process 700 may include receiving configuration information indicative of a carrier aggregation configuration associated with a first CC and a second CC (block 710). For example, the UE (e.g., using communication manager 908 and/or reception component 902, depicted in FIG. 9) may receive configuration information indicative of a carrier aggregation configuration associated with a first CC and a second CC, as described above.

As further shown in FIG. 7, in some aspects, process 700 may include receiving scheduling information indicative of at least one scheduled transmission during a transmission occasion associated with at least one of the first CC or the second CC (block 720). For example, the UE (e.g., using communication manager 908 and/or reception component 902, depicted in FIG. 9) may receive scheduling information indicative of at least one scheduled transmission during a transmission occasion associated with at least one of the first CC or the second CC, as described above.

As further shown in FIG. 7, in some aspects, process 700 may include transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit (block 730). For example, the UE (e.g., using communication manager 908 and/or transmission component 904, depicted in FIG. 9) may transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit, as described above.

Process 700 may include additional aspects, such as any single aspect or any combination of aspects described below and/or in connection with one or more other processes described elsewhere herein.

In a first aspect, the first PHR reference value comprises a maximum of a first per band UE power class and a first per band per-band-combination UE power class associated with the carrier aggregation configuration.

In a second aspect, alone or in combination with the first aspect, the at least one scheduled transmission comprises, during the transmission occasion, only a first transmission associated with the first CC.

In a third aspect, alone or in combination with one or more of the first and second aspects, basing on the at least one scheduled transmission comprising only the first transmission during the transmission occasion, the first maximum transmission power limit is based on a first per band UE power class and a first per band per-band-combination UE power class.

In a fourth aspect, alone or in combination with one or more of the first through third aspects, the at least one scheduled transmission comprises two parallel transmissions during the transmission occasion, and the first maximum transmission power limit is based at least in part on a carrier aggregation power class.

In a fifth aspect, alone or in combination with one or more of the first through fourth aspects, the at least one transmission power comprises a second transmission power associated with the second CC, and the second transmission power is based on a second maximum transmission power limit based at least in part on the carrier aggregation power class.

In a sixth aspect, alone or in combination with one or more of the first through fifth aspects, the at least one scheduled transmission comprises two non-parallel transmissions during the transmission occasion, and the first maximum transmission power limit is based at least in part on a first per-band UE power class.

In a seventh aspect, alone or in combination with one or more of the first through sixth aspects, the at least one transmission power further comprises a second transmission power associated with the second CC, wherein the second transmission power is based at least in part on a second PHR reference value associated with the second CC.

In an eighth aspect, alone or in combination with one or more of the first through seventh aspects, the second PHR reference value comprises a maximum of a second per-band UE power class and a second per band per-band-combination UE power class associated with carrier aggregation.

In a ninth aspect, alone or in combination with one or more of the first through eighth aspects, the second transmission power is based on a second maximum transmission power limit based at least in part on a second per-band UE power class, and the second PHR reference value is determined independently of the second maximum transmission power limit.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 604) performs operations associated with stable PHR reference values for carrier aggregation.

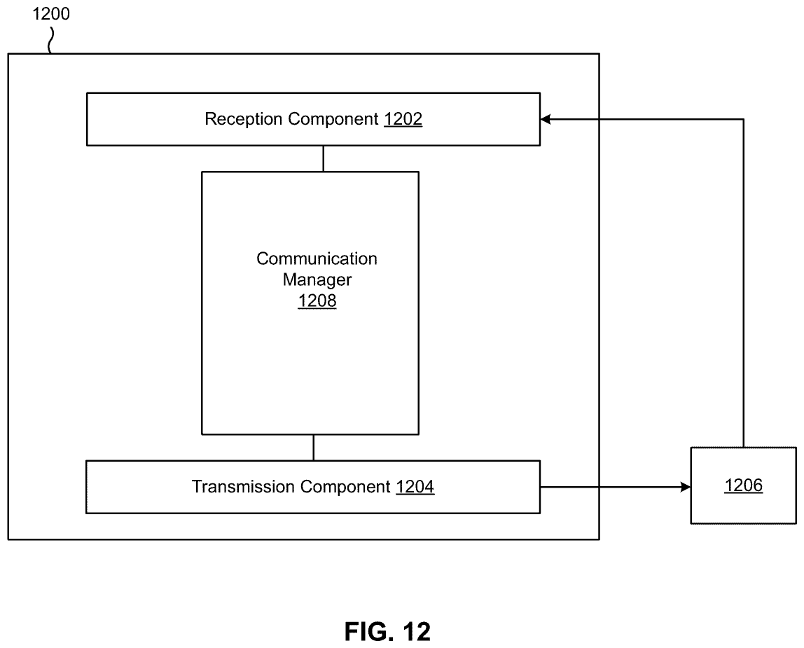

As shown in FIG. 8, in some aspects, process 800 may include transmitting configuration information indicative of a carrier aggregation configuration associated with a first CC and a second CC (block 810). For example, the network node (e.g., using communication manager 1208 and/or transmission component 1204, depicted in FIG. 12) may transmit configuration information indicative of a carrier aggregation configuration associated with a first CC and a second CC, as described above.

As further shown in FIG. 8, in some aspects, process 800 may include transmitting scheduling information indicative of at least one scheduled transmission during a transmission occasion associated with at least one of the first CC or the second CC (block 820). For example, the network node (e.g., using communication manager 1208 and/or transmission component 1204, depicted in FIG. 12) may transmit scheduling information indicative of at least one scheduled transmission during a transmission occasion associated with at least one of the first CC or the second CC, as described above.

As further shown in FIG. 8, in some aspects, process 800 may include receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit (block 830). For example, the network node (e.g., using communication manager 1208 and/or reception component 1202, depicted in FIG. 12) may receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit, as described above.

Process 800 may include additional aspects, such as any single aspect or any combination of aspects described below and/or in connection with one or more other processes described elsewhere herein.

In a first aspect, the first PHR reference value comprises a maximum of a first per band UE power class and a first per band per-band-combination UE power class associated with the carrier aggregation configuration.

In a second aspect, alone or in combination with the first aspect, the at least one scheduled transmission comprises, during the transmission occasion, only a first transmission associated with the first CC.

In a third aspect, alone or in combination with one or more of the first and second aspects, basing on the at least one scheduled transmission comprising only the first transmission during the transmission occasion, the first maximum transmission power limit is based on a first per band UE power class and a first per band per-band-combination UE power class.

In a fourth aspect, alone or in combination with one or more of the first through third aspects, the at least one scheduled transmission comprises two parallel transmissions during the transmission occasion, and the first maximum transmission power limit is based at least in part on a carrier aggregation power class.

In a fifth aspect, alone or in combination with one or more of the first through fourth aspects, the at least one transmission power comprises a second transmission power associated with the second CC, and the second transmission power is based on a second maximum transmission power limit based at least in part on the carrier aggregation power class.

In a sixth aspect, alone or in combination with one or more of the first through fifth aspects, the at least one scheduled transmission comprises two non-parallel transmissions during the transmission occasion, and the first maximum transmission power limit is based at least in part on a first per-band UE power class.

In a seventh aspect, alone or in combination with one or more of the first through sixth aspects, the at least one transmission power further comprises a second transmission power associated with the second CC, wherein the second transmission power is based at least in part on a second PHR reference value associated with the second CC.

In an eighth aspect, alone or in combination with one or more of the first through seventh aspects, the second PHR reference value comprises a maximum of a second per-band UE power class and a second per band per-band-combination UE power class associated with carrier aggregation.

In a ninth aspect, alone or in combination with one or more of the first through eighth aspects, the second transmission power is based on a second maximum transmission power limit based at least in part on a second per-band UE power class, and the second PHR reference value is determined independently of the second maximum transmission power limit.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 908.

In some aspects, the apparatus 900 may be configured to perform one or more operations described herein in connection with FIGS. 5A-6B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 906.

In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 908 may support operations of the reception component 902 and/or the transmission component 904. For example, the communication manager 908 may receive information associated with configuring reception of communications by the reception component 902 and/or transmission of communications by the transmission component 904. Additionally, or alternatively, the communication manager 908 may generate and/or provide control information to the reception component 902 and/or the transmission component 904 to control reception and/or transmission of communications. In some aspects, the communication manager 908 may include the reception component 902 and/or the transmission component 904. In some aspects, the communication manager 908 may be, be similar to, include, or be included in, the communication manager 140 depicted in FIGS. 1 and 2.

The communication manager 908 and/or the reception component 902 may receive configuration information indicative of a carrier aggregation configuration associated with a first CC and a second CC. The communication manager 908 and/or the reception component 902 may receive scheduling information indicative of at least one scheduled transmission during a transmission occasion associated with at least one of the first CC or the second CC. The communication manager 908 and/or the transmission component 904 may transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

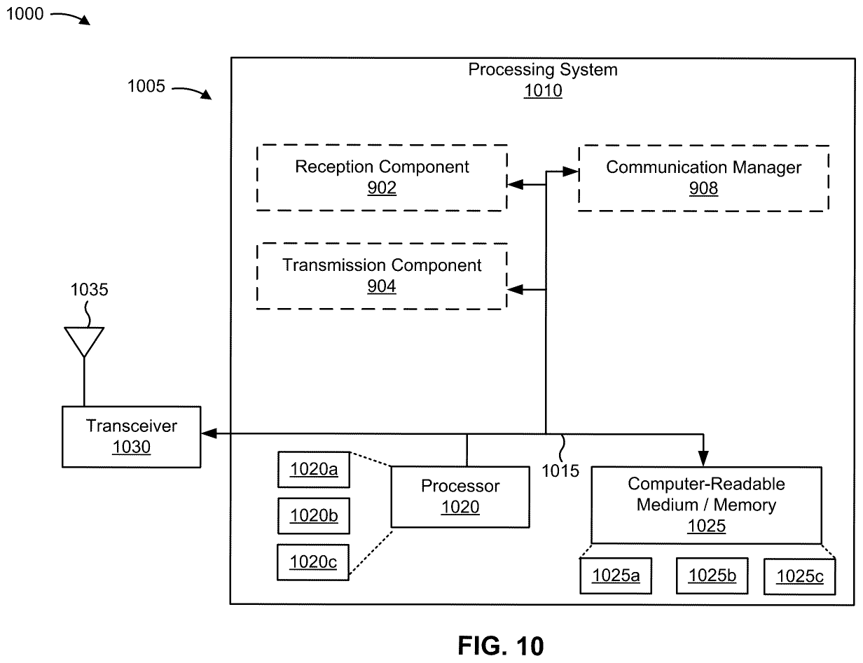

FIG. 10 is a diagram illustrating an example 1000 of a hardware implementation for an apparatus 1005 employing a processing system 1010, in accordance with the present disclosure. The apparatus 1005 may be a UE or may be at (e.g., included in) a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor (or processing circuitry) 1020, the illustrated components, and the computer-readable medium/memory (or memory circuitry) 1025. The processor 1020 may include multiple processors, such as processor 1020a, memory 1020b, and memory 1020c. The memory 1025 may include multiple memories, such as memory 1025a, memory 1025b, and memory 1025c. The bus 1015 may also link various other circuits, such as timing sources, peripherals, voltage regulators, and/or power management circuits.

The processing system 1010 may be coupled to one or more transceivers 1030. A transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes one or more processors 1020 coupled to a computer-readable medium/memory 1025. A processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 and may include one or more memories, such as the memory 282, and/or may include one or more processors, such as at least one of the TX MIMO processor 266, the RX processor 258, and/or the controller/processor 280. In some aspects, the apparatus 1005 for wireless communication includes means for receiving configuration information indicative of a carrier aggregation configuration associated with a first CC and a second CC; receiving scheduling information indicative of at least one scheduled transmission during a transmission occasion associated with at least one of the first CC or the second CC; and transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit. The aforementioned means may be one or more of the aforementioned components of the apparatus 900 and/or the processing system 1010 of the apparatus 1005 configured to perform the functions recited by the aforementioned means. As described elsewhere herein, the processing system 1010 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

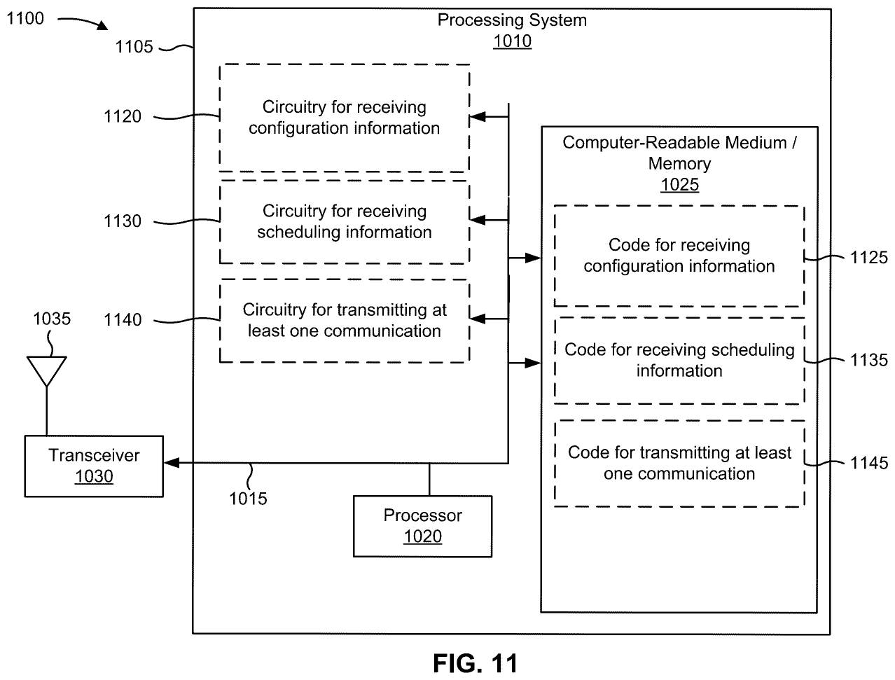

FIG. 11 is a diagram illustrating an example 1100 of an implementation of code and circuitry for an apparatus 1105, in accordance with the present disclosure. The circuitry may include processing circuitry and memory circuitry. The apparatus 1105 may be a UE, or a UE may include the apparatus 1105.

As shown in FIG. 11, the apparatus 1105 may include circuitry for receiving configuration information (circuitry 1120). For example, the circuitry 1120 may enable the apparatus 1105 to receive configuration information indicative of a carrier aggregation configuration associated with a first CC and a second CC.

As shown in FIG. 11, the apparatus 1105 may include, stored in computer-readable medium 1025, code for receiving configuration information (code 1125). For example, the code 1125, when executed by processor 1020, may cause processor 1020 to cause transceiver 1030 to receive configuration information indicative of a carrier aggregation configuration associated with a first CC and a second CC.

As shown in FIG. 11, the apparatus 1105 may include circuitry for receiving scheduling information (circuitry 1130). For example, the circuitry 1130 may enable the apparatus 1105 to receive scheduling information indicative of at least one scheduled transmission during a transmission occasion associated with at least one of the first CC or the second CC.

As shown in FIG. 11, the apparatus 1105 may include, stored in computer-readable medium 1025, code for receiving scheduling information (code 1135). For example, the code 1135, when executed by processor 1020, may cause processor 1020 to cause transceiver 1030 to receive scheduling information indicative of at least one scheduled transmission during a transmission occasion associated with at least one of the first CC or the second CC.

As shown in FIG. 11, the apparatus 1105 may include circuitry for transmitting at least one communication (circuitry 1140). For example, the circuitry 1140 may enable the apparatus 1105 to transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

As shown in FIG. 11, the apparatus 1105 may include, stored in computer-readable medium 1025, code for transmitting at least one communication (code 1145). For example, the code 1145, when executed by processor 1020, may cause processor 1020 to cause transceiver 1030 to transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

FIG. 11 is provided as an example. Other examples may differ from what is described in connection with FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208.

In some aspects, the apparatus 1200 may be configured to perform one or more operations described herein in connection with FIGS. 5A-6B. Additionally, or alternatively, the apparatus 1200 may be configured to perform one or more processes described herein, such as process 800 of FIG. 8. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1208 may support operations of the reception component 1202 and/or the transmission component 1204. For example, the communication manager 1208 may receive information associated with configuring reception of communications by the reception component 1202 and/or transmission of communications by the transmission component 1204. Additionally, or alternatively, the communication manager 1208 may generate and/or provide control information to the reception component 1202 and/or the transmission component 1204 to control reception and/or transmission of communications. In some aspects, the communication manager 1208 may include the reception component 1202 and/or the transmission component 1204. In some aspects, the communication manager 1208 may be, be similar to, include, or be included in, the communication manager 150 depicted in FIGS. 1 and 2.

The communication manager 1208 and/or the transmission component 1204 may transmit configuration information indicative of a carrier aggregation configuration associated with a first CC and a second CC. The communication manager 1208 and/or the transmission component 1204 may transmit scheduling information indicative of at least one scheduled transmission during a transmission occasion associated with at least one of the first CC or the second CC. The communication manager 1208 and/or the reception component 1202 may receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

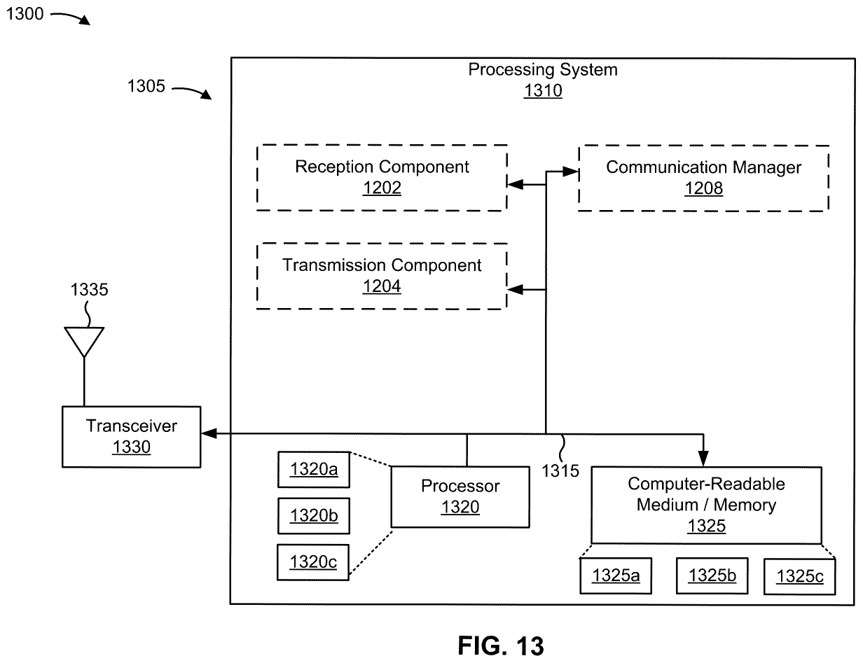

FIG. 13 is a diagram illustrating an example 1300 of a hardware implementation for an apparatus 1305 employing a processing system 1310, in accordance with the present disclosure. The apparatus 1305 may be a network node or may be at (e.g., included in) a network node.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor (or processing circuitry) 1320, the illustrated components, and the computer-readable medium/memory (or memory circuitry) 1325. The processor 1320 may include multiple processors, such as processor 1320a, memory 1320b, and memory 1320c. The memory 1325 may include multiple memories, such as memory 1325a, memory 1325b, and memory 1325c. The bus 1315 may also link various other circuits, such as timing sources, peripherals, voltage regulators, and/or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 1305 for wireless communication includes means for transmitting configuration information indicative of a carrier aggregation configuration associated with a first CC and a second CC; transmitting scheduling information indicative of at least one scheduled transmission during a transmission occasion associated with at least one of the first CC or the second CC; and receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 13 is provided as an example. Other examples may differ from what is described in connection with FIG. 13.

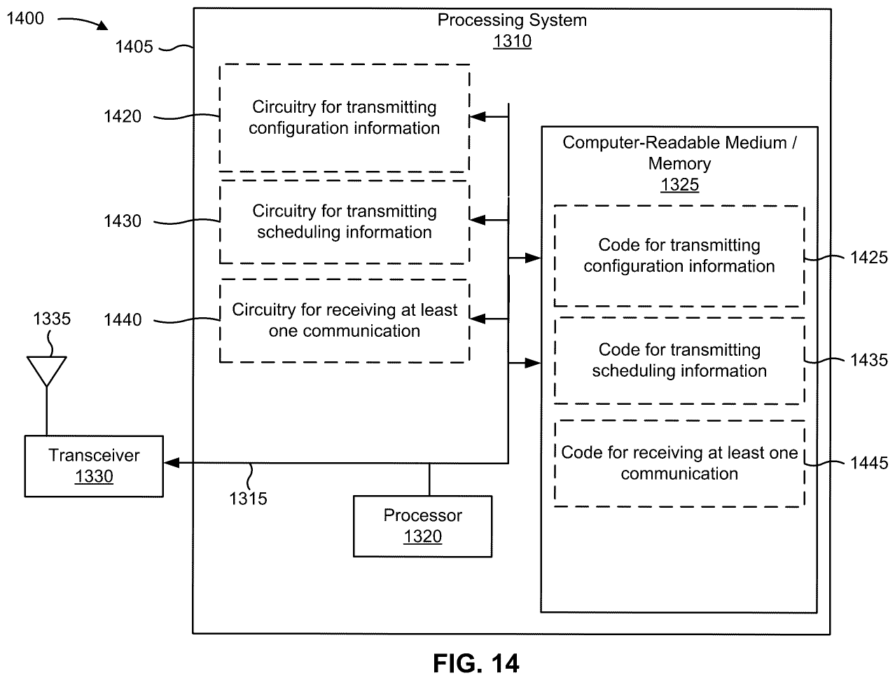

FIG. 14 is a diagram illustrating an example 1400 of an implementation of code and circuitry for an apparatus 1405, in accordance with the present disclosure. The circuitry may include processing circuitry and memory circuitry. The apparatus 1405 may be a UE, or a UE may include the apparatus 1405.

As shown in FIG. 14, the apparatus 1405 may include circuitry for transmitting configuration information (circuitry 1420). For example, the circuitry 1420 may enable the apparatus 1405 to transmit configuration information indicative of a carrier aggregation configuration associated with a first CC and a second CC.

As shown in FIG. 14, the apparatus 1405 may include, stored in computer-readable medium 1325, code for transmitting configuration information (code 1425). For example, the code 1425, when executed by processor 1320, may cause processor 1320 to cause transceiver 1330 to transmit configuration information indicative of a carrier aggregation configuration associated with a first CC and a second CC.

As shown in FIG. 14, the apparatus 1405 may include circuitry for transmitting scheduling information (circuitry 1430). For example, the circuitry 1430 may enable the apparatus 1405 to transmit scheduling information indicative of at least one scheduled transmission during a transmission occasion associated with at least one of the first CC or the second CC.

As shown in FIG. 14, the apparatus 1405 may include, stored in computer-readable medium 1325, code for transmitting scheduling information (code 1435). For example, the code 1435, when executed by processor 1320, may cause processor 1320 to cause transceiver 1330 to transmit scheduling information indicative of at least one scheduled transmission during a transmission occasion associated with at least one of the first CC or the second CC.

As shown in FIG. 14, the apparatus 1405 may include circuitry for receiving at least one communication (circuitry 1440). For example, the circuitry 1440 may enable the apparatus 1405 to receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

As shown in FIG. 14, the apparatus 1405 may include, stored in computer-readable medium 1325, code for receiving at least one communication (code 1445). For example, the code 1445, when executed by processor 1320, may cause processor 1320 to cause transceiver 1330 to receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first PHR reference value associated with the first CC, and wherein the first PHR reference value is determined independently of the first maximum transmission power limit.

FIG. 14 is provided as an example. Other examples may differ from what is described in connection with FIG. 14.

The following provides an overview of some Aspects of the present disclosure:

Aspect 1: A method of wireless communication performed at a user equipment (UE), comprising: receiving configuration information indicative of a carrier aggregation configuration associated with a first component carrier (CC) and a second CC; receiving scheduling information indicative of at least one scheduled transmission during a transmission occasion associated with at least one of the first CC or the second CC; and transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

Aspect 2: The method of Aspect 1, wherein the first PHR reference value comprises a maximum of a first per band UE power class and a first per band per-band-combination UE power class associated with the carrier aggregation configuration.

Aspect 3: The method of either of claim 1 or 2, wherein the at least one scheduled transmission comprises, during the transmission occasion, only a first transmission associated with the first CC.

Aspect 4: The method of Aspect 3, wherein, based on the at least one scheduled transmission comprising only the first transmission during the transmission occasion, the first maximum transmission power limit is based on a first per band UE power class and a first per band per-band-combination UE power class.

Aspect 5: The method of either of claim 1 or 2, wherein the at least one scheduled transmission comprises two parallel transmissions during the transmission occasion, and wherein the first maximum transmission power limit is based at least in part on a carrier aggregation power class.

Aspect 6: The method of Aspect 5, wherein the at least one transmission power comprises a second transmission power associated with the second CC, and wherein the second transmission power is based on a second maximum transmission power limit based at least in part on the carrier aggregation power class.

Aspect 7: The method of either of claim 1 or 2, wherein the at least one scheduled transmission comprises two non-parallel transmissions during the transmission occasion, and wherein the first maximum transmission power limit is based at least in part on a first per-band UE power class.

Aspect 8: The method of Aspect 7, wherein the at least one transmission power further comprises a second transmission power associated with the second CC, wherein the second transmission power is based at least in part on a second PHR reference value associated with the second CC.

Aspect 9: The method of Aspect 8, wherein the second PHR reference value comprises a maximum of a second per-band UE power class and a second per band per-band-combination UE power class associated with carrier aggregation.

Aspect 10: The method of either of Aspects 8 or 9, wherein the second transmission power is based on a second maximum transmission power limit based at least in part on a second per-band UE power class, and wherein the second PHR reference value is determined independently of the second maximum transmission power limit.

Aspect 11: A method of wireless communication performed at a network node, comprising: transmitting configuration information indicative of a carrier aggregation configuration associated with a first component carrier (CC) and a second CC; transmitting scheduling information indicative of at least one scheduled transmission during a transmission occasion associated with at least one of the first CC or the second CC; and receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

Aspect 12: The method of Aspect 11, wherein the first PHR reference value comprises a maximum of a first per band UE power class and a first per band per-band-combination UE power class associated with the carrier aggregation configuration.

Aspect 13: The method of either of claim 11 or 12, wherein the at least one scheduled transmission comprises, during the transmission occasion, only a first transmission associated with the first CC.

Aspect 14: The method of Aspect 13, wherein, based on the at least one scheduled transmission comprising only the first transmission during the transmission occasion, the first maximum transmission power limit is based on a first per band UE power class and a first per band per-band-combination UE power class.

Aspect 15: The method of either of claim 11 or 12, wherein the at least one scheduled transmission comprises two parallel transmissions during the transmission occasion, and wherein the first maximum transmission power limit is based at least in part on a carrier aggregation power class.

Aspect 16: The method of Aspect 15, wherein the at least one transmission power comprises a second transmission power associated with the second CC, and wherein the second transmission power is based on a second maximum transmission power limit based at least in part on the carrier aggregation power class.

Aspect 17: The method of either of claim 11 or 12, wherein the at least one scheduled transmission comprises two non-parallel transmissions during the transmission occasion, and wherein the first maximum transmission power limit is based at least in part on a first per-band UE power class.

Aspect 18: The method of Aspect 17, wherein the at least one transmission power further comprises a second transmission power associated with the second CC, wherein the second transmission power is based at least in part on a second PHR reference value associated with the second CC.

Aspect 19: The method of Aspect 18, wherein the second PHR reference value comprises a maximum of a second per-band UE power class and a second per band per-band-combination UE power class associated with carrier aggregation.

Aspect 20: The method of either of Aspects 18 or 19, wherein the second transmission power is based on a second maximum transmission power limit based at least in part on a second per-band UE power class, and wherein the second PHR reference value is determined independently of the second maximum transmission power limit.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-10.

Aspect 22: An apparatus for wireless communication at a device, the apparatus comprising one or more memories and one or more processors coupled to the one or more memories, the one or more processors configured to cause the device to perform the method of one or more of Aspects 1-10.

Aspect 23: An apparatus for wireless communication, the apparatus comprising at least one means for performing the method of one or more of Aspects 1-10.

Aspect 24: A non-transitory computer-readable medium storing code for wireless communication, the code comprising instructions executable by one or more processors to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: A device for wireless communication, the device comprising a processing system that includes one or more processors and one or more memories coupled with the one or more processors, the processing system configured to cause the device to perform the method of one or more of Aspects 1-10.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-10.

Aspect 28: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-10.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 11-20.

Aspect 30: An apparatus for wireless communication at a device, the apparatus comprising one or more memories and one or more processors coupled to the one or more memories, the one or more processors configured to cause the device to perform the method of one or more of Aspects 11-20.

Aspect 31: An apparatus for wireless communication, the apparatus comprising at least one means for performing the method of one or more of Aspects 11-20.

Aspect 32: A non-transitory computer-readable medium storing code for wireless communication, the code comprising instructions executable by one or more processors to perform the method of one or more of Aspects 11-20.

Aspect 33: A non-transitory computer-readable medium storing a set of instructions for wireless communication, the set of instructions comprising one or more instructions that, when executed by one or more processors of a device, cause the device to perform the method of one or more of Aspects 11-20.

Aspect 34: A device for wireless communication, the device comprising a processing system that includes one or more processors and one or more memories coupled with the one or more processors, the processing system configured to cause the device to perform the method of one or more of Aspects 11-20.

Aspect 35: An apparatus for wireless communication at a device, the apparatus comprising one or more memories and one or more processors coupled to the one or more memories, the one or more processors individually or collectively configured to cause the device to perform the method of one or more of Aspects 11-20.

Aspect 36: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 11-20.

Aspect 37: An apparatus for wireless communication at a user equipment (UE), comprising: one or more memories; and one or more processors coupled to the one or more memories, the one or more processors configured to cause the UE to: receive configuration information indicative of a carrier aggregation configuration associated with a first component carrier (CC) and a second CC; receive scheduling information indicative of at least one scheduled transmission during a transmission occasion associated with at least one of the first CC or the second CC; and transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

Aspect 38: An apparatus for wireless communication at a user equipment (UE), comprising: one or more memories; and one or more processors coupled to the one or more memories, the one or more processors configured to cause the UE to: receive configuration information indicative of a carrier aggregation configuration associated with a first component carrier (CC) and a second CC; receive scheduling information indicative of at least one scheduled transmission during a transmission occasion associated with at least one of the first CC or the second CC; and transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

Aspect 39: An apparatus for wireless communication at a network node, comprising: one or more memories; and one or more processors coupled to the one or more memories, the one or more processors configured to cause the network node to: transmit configuration information indicative of a carrier aggregation configuration associated with a first component carrier (CC) and a second CC; transmit scheduling information indicative of at least one scheduled transmission during a transmission occasion associated with at least one of the first CC or the second CC; and receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

Aspect 40: An apparatus for wireless communication at a network node, comprising: one or more memories; and one or more processors coupled to the one or more memories, the one or more processors configured to cause the network node to: transmit configuration information indicative of a carrier aggregation configuration associated with a first component carrier (CC) and a second CC; transmit scheduling information indicative of at least one scheduled transmission during a transmission occasion associated with at least one of the first CC or the second CC; and receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and configured to cause the UE to:
receive configuration information indicative of a carrier aggregation configuration associated with a first component carrier (CC) and a second CC;
receive scheduling information indicative of at least one scheduled transmission during a transmission occasion associated with at least one of the first CC or the second CC; and
transmit, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

2. The apparatus of claim 1, wherein the first PHR reference value comprises a maximum of a first per band UE power class and a first per band per-band-combination UE power class associated with the carrier aggregation configuration.

3. The apparatus of claim 1, wherein the at least one scheduled transmission comprises, during the transmission occasion, only a first transmission associated with the first CC.

4. The apparatus of claim 3, wherein, based on the at least one scheduled transmission comprising only the first transmission during the transmission occasion, the first maximum transmission power limit is based on a first per band UE power class and a first per band per-band-combination UE power class.

5. The apparatus of claim 1, wherein the at least one scheduled transmission comprises two parallel transmissions during the transmission occasion, and wherein the first maximum transmission power limit is based at least in part on a carrier aggregation power class.

6. The apparatus of claim 5, wherein the at least one transmission power comprises a second transmission power associated with the second CC, and wherein the second transmission power is based on a second maximum transmission power limit based at least in part on the carrier aggregation power class.

7. The apparatus of claim 1, wherein the at least one scheduled transmission comprises two non-parallel transmissions during the transmission occasion, and wherein the first maximum transmission power limit is based at least in part on a first per-band UE power class.

8. The apparatus of claim 7, wherein the at least one transmission power further comprises a second transmission power associated with the second CC, wherein the second transmission power is based at least in part on a second PHR reference value associated with the second CC.

9. The apparatus of claim 8, wherein the second PHR reference value comprises a maximum of a second per-band UE power class and a second per band per-band-combination UE power class associated with carrier aggregation.

10. The apparatus of claim 8, wherein the second transmission power is based on a second maximum transmission power limit based at least in part on a second per-band UE power class, and wherein the second PHR reference value is determined independently of the second maximum transmission power limit.

11. An apparatus for wireless communication at a network node, comprising:
one or more memories; and
one or more processors coupled with the one or more memories and configured to cause the network node to:
transmit configuration information indicative of a carrier aggregation configuration associated with a first component carrier (CC) and a second CC;
transmit scheduling information indicative of at least one scheduled transmission during a transmission occasion associated with at least one of the first CC or the second CC; and
receive, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

12. The apparatus of claim 11, wherein the first PHR reference value comprises a maximum of a first per band UE power class and a first per band per-band-combination UE power class associated with the carrier aggregation configuration.

13. The apparatus of claim 11, wherein the at least one scheduled transmission comprises, during the transmission occasion, only a first transmission associated with the first CC.

14. The apparatus of claim 13, wherein, based on the at least one scheduled transmission comprising only the first transmission during the transmission occasion, the first maximum transmission power limit is based on a first per band UE power class and a first per band per-band-combination UE power class.

15. The apparatus of claim 11, wherein the at least one scheduled transmission comprises two parallel transmissions during the transmission occasion, and wherein the first maximum transmission power limit is based at least in part on a carrier aggregation power class.

16. The apparatus of claim 15, wherein the at least one transmission power comprises a second transmission power associated with the second CC, and wherein the second transmission power is based on a second maximum transmission power limit based at least in part on the carrier aggregation power class.

17. The apparatus of claim 11, wherein the at least one scheduled transmission comprises two non-parallel transmissions during the transmission occasion, and wherein the first maximum transmission power limit is based at least in part on a first per-band UE power class.

18. The apparatus of claim 17, wherein the at least one transmission power further comprises a second transmission power associated with the second CC, wherein the second transmission power is based at least in part on a second PHR reference value associated with the second CC.

19. The apparatus of claim 18, wherein the second PHR reference value comprises a maximum of a second per-band UE power class and a second per band per-band-combination UE power class associated with carrier aggregation.

20. The apparatus of claim 18, wherein the second transmission power is based on a second maximum transmission power limit based at least in part on a second per-band UE power class, and wherein the second PHR reference value is determined independently of the second maximum transmission power limit.

21. A method of wireless communication performed at a user equipment (UE), comprising:
receiving configuration information indicative of a carrier aggregation configuration associated with a first component carrier (CC) and a second CC;
receiving scheduling information indicative of at least one scheduled transmission during a transmission occasion associated with at least one of the first CC or the second CC; and
transmitting, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

22. The method of claim 21, wherein the first PHR reference value comprises a maximum of a first per band UE power class and a first per band per-band-combination UE power class associated with the carrier aggregation configuration.

23. The method of claim 21, wherein the at least one scheduled transmission comprises, during the transmission occasion, only a first transmission associated with the first CC.

24. The method of claim 23, wherein, based on the at least one scheduled transmission comprising only the first transmission during the transmission occasion, the first maximum transmission power limit is based on a first per band UE power class and a first per band per-band-combination UE power class.

25. The method of claim 21, wherein the at least one scheduled transmission comprises two parallel transmissions during the transmission occasion, and wherein the first maximum transmission power limit is based at least in part on a carrier aggregation power class.

26. A method of wireless communication performed at a network node, comprising:
transmitting configuration information indicative of a carrier aggregation configuration associated with a first component carrier (CC) and a second CC;
transmitting scheduling information indicative of at least one scheduled transmission during a transmission occasion associated with at least one of the first CC or the second CC; and
receiving, using at least one transmission power during the transmission occasion, at least one communication on the at least one of the first CC or the second CC, the at least one transmission power comprising a first transmission power associated with the first CC, wherein the first transmission power is based at least in part on a first maximum transmission power limit associated with the first CC and a first power headroom (PHR) reference value associated with the first CC, and wherein the first PHR reference value is determined independently of the first maximum transmission power limit.

27. The method of claim 26, wherein the at least one scheduled transmission comprises two non-parallel transmissions during the transmission occasion, and wherein the first maximum transmission power limit is based at least in part on a first per-band UE power class.

28. The method of claim 27, wherein the at least one transmission power further comprises a second transmission power associated with the second CC, wherein the second transmission power is based at least in part on a second PHR reference value associated with the second CC.

29. The method of claim 28, wherein the second PHR reference value comprises a maximum of a second per-band UE power class and a second per band per-band-combination UE power class associated with carrier aggregation.

30. The method of claim 28, wherein the second transmission power is based on a second maximum transmission power limit based at least in part on a second per-band UE power class, and wherein the second PHR reference value is determined independently of the second maximum transmission power limit.
